(19) United States
(12) Patent Application Publication
(10) Pub. No.: US 2018/0079959 A1
(43) Pub. Date: Mar. 22, 2018

(54) LIQUID CRYSTAL ELEMENT WITH NEGATIVE DIELECTRIC ANISOTROPY

(71) Applicant: DIC Corporation, Tokyo (JP)

(72) Inventors: Masakazu Kaneoya, Kita-adachi-gun (JP); Kiyofumi Takeuchi, Kita-adachi-gun (JP); Hidetoshi Nakata, Kita-adachi-gun (JP)

(73) Assignee: DIC Corporation, Tokyo (JP)

(21) Appl. No.: 15/554,285

(22) PCT Filed: Mar. 1, 2016
(86) PCT No.: PCT/JP2016/056215

§ 371 Date: Aug. 29, 2017

(30) Foreign Application Priority Data
Mar. 11, 2015 (JP) 2015-048324

(51) Int. Cl. C09K 19/46; C09K 19/56; C09K 19/44; C09K 19/38; C09K 19/32; C09K 19/30; G02F 1/1337; G02F 1/137

(52) U.S. Cl. CPC C09K 19/46; C09K 19/56; C09K 19/44; C09K 19/3804; C09K 19/3809; C09K 19/322; C09K 2019/0448; G02F 1/1337; G02F 1/137; C09K 2019/3004; C09K 2019/301; C09K 2019/3016; C09K 19/3003

(57) ABSTRACT

An object of the present invention is to provide a liquid crystal element which sufficiently optimizes mainly the electrooptical properties of a VA display, has a wide operating temperature range, a high-speed responsiveness at a low temperature, a halftone response speed, a high contrast, a wide viewing angle, a low threshold voltage, and a high resistance value, and includes a small amount of residual monomers and shows a high voltage holding ratio, even after polymerization of a polymerizable liquid crystal compound is performed. As a result of intensive studies to achieve the object described above, the inventors found the optimal configuration of a liquid crystal element and completed the present invention.

### TECHNICAL FIELD

The present invention relates to a liquid crystal element using a liquid crystal with negative dielectric anisotropy which is useful as an electrooptical liquid crystal display material.

### BACKGROUND ART

From a viewpoint of excellent display quality, an active matrix-type liquid crystal display device is used in the markets of portable terminals, liquid crystal televisions, projectors, computers, and the like. In an active matrix display system, a thin film transistor (TFT) or a metal insulator metal (MIM) is used for each pixel, and it is important that a high voltage holding ratio is maintained in this system. In addition, in order to obtain wider visual angle properties, a TFT display in combination with VA, IPS, or OCB mode is proposed, and in order to realize brighter display, a reflective type of an ECB mode is proposed. In order to deal with such display elements, new liquid crystal compounds or liquid crystal compositions are currently proposed.

A vertical alignment (VA) display, in which a liquid crystal medium having negative dielectric anisotropy which has particularly been demanded increasingly in recent years is used, shows a higher response speed than other types of displays, but a halftone response speed is slightly slow, and thus, it is necessary that further improvement is performed. In the liquid crystal medium, the improvement can be performed by decreasing a rotational viscosity (γ1). In addition, in the VA display, it is necessary to control a tilt direction of liquid crystal molecules at the time of applying a voltage. As a control method, a method of performing rubbing with respect to an alignment film, adding protrusions into a cell, slightly shifting the positions of upper and lower transparent electrodes, or providing a slit in a transparent electrode is disclosed (PTL 2). A technology of adding a small amount of a polymerizable liquid crystal compound into a liquid crystal medium and causing polymerization in a cell, to set an arbitrary pre-tilt angle is disclosed as a new technology (PTL 3).

However, it is not yet possible to sufficiently optimize the electrooptical properties of the VA display, even when a liquid crystal medium which has been available until now is used. There are continuous demands for a display that has a wide operating temperature range, a high-speed responsiveness at a low temperature, a halftone response speed, a high contrast, a wide viewing angle, a low threshold voltage, and a high resistance value, and includes a small amount of residual monomers and shows a high voltage holding ratio, even after polymerization of a polymerizable liquid crystal compound is performed.

A liquid crystal medium showing a high VHR value and a low rotational viscosity is disclosed in (PTL 1), but in a case where a liquid crystal medium including a compound of Formula (1), the content of which is greater than 10%, is used, a percentage of residual monomers is significantly increased, this causes a decrease in a VHR value and an increase in an ID value, and thus, the display quality is not sufficient. In addition, the rotational viscosity is not sufficient, either.

A method of using gas chromatography (GC) is disclosed in Page 12 of (PTL 4) as a simple measurement method of the amount of a polymerizable compound remaining in a liquid crystal phase after polymerization, but it is difficult to quantitatively measure the amount of the polymerizable compounds after the polymerization reaction which may have various molecular weights by the GC, and thus, reliability of a measurement result is low.

### CITATION LIST

### Patent Literature

[PTL 1] JP-A-2004-131704

[PTL 2] JP-A-11-242225

[PTL 3] JP-A-2002-357830

[PTL 4] JP-A-2006-078968

### SUMMARY OF INVENTION

### Technical Problem

An object of the present invention is to provide a liquid crystal element which sufficiently optimizes mainly the electrooptical properties of a VA display, has a wide operating temperature range, a high-speed responsiveness at a low temperature, a halftone response speed, a high contrast, a wide viewing angle, a low threshold voltage, and a high resistance value, and includes a small amount of residual monomers and shows a high voltage holding ratio, even after polymerization of a polymerizable liquid crystal compound is performed.

### Solution to Problem

As a result of intensive studies to solve the aforementioned problems, the inventors found the optimal configuration of a liquid crystal element and completed the present invention.

### Advantageous Effects of Invention

A liquid crystal element of the present invention uses a liquid crystal composition including a liquid crystal compound which has three or four ring structures and a negative dielectric anisotropy (Δ∈) whose absolute value is 1 or more, a liquid crystal compound which has two, three, or four ring structures and a dielectric anisotropy (Δ∈) whose absolute value is 1 or less, and a polymerizable compound, wherein the total content of these compounds is 95% or more, and one or more of compounds represented by General Formula (1) is used as the liquid crystal compound having a dielectric anisotropy (Δ∈) whose absolute value 1 or more, thereby obtaining a high voltage holding ratio, a low ion density, and a high resistance value. In addition, it is possible to decrease the amount of residual monomers, and thus, excellent long team stability is obtained and display quality is improved.

### BRIEF DESCRIPTION OF DRAWINGS

FIG. 1 is a relational graph between a liquid crystal composition and a residual monomer.

FIG. 2 is a relational graph between a liquid crystal composition and a VHR (after polymerization process).

FIG. 3 is a relational graph between a liquid crystal composition and an ID (after polymerization process).

### DESCRIPTION OF EMBODIMENTS

According to the present invention, there is provided a liquid crystal element, in which a liquid crystal composition is disposed between a pair of substrates on which a transparent electrode and an alignment film are formed, the liquid crystal composition includes a liquid crystal compound which has three or four ring structures and a negative dielectric anisotropy (Δ∈) whose absolute value is 1 or more; a liquid crystal compound which has two, three, or four ring structures and a dielectric anisotropy (Δ∈) whose absolute value is 1 or less; and a polymer of a polymerizable compound, the total content of the liquid crystal compound which has three or four ring structures and a negative dielectric anisotropy (Δ∈) whose absolute value is 1 or more, the liquid crystal compound which has two, three, or four ring structures and a dielectric anisotropy (Δ∈) whose absolute value is 1 or less, and the polymerizable compound before polymerization in the liquid crystal composition used in the liquid crystal element is 95% or more of the total content of the liquid crystal composition and the polymerizable compound before polymerization, and the liquid crystal compound which has three or four ring structures and a negative dielectric anisotropy (Δ∈) whose absolute value is 1 or more includes one or more of compounds represented by General Formula (1):

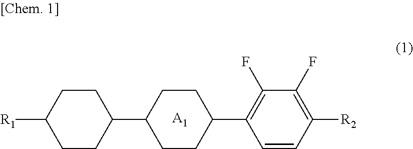

wherein R₁ and R₂ each independently represent an alkyl group having 1 to 15 carbon atoms, at least one CH₂ group in the alkyl group may be substituted with —O—, —CH═CH—, —CO—, —OCO—, —COO—, —C≡C—, CF₂O—, and —OCF₂—, provided that O atoms are not directly adjacent to each other, at least one H atom in the alkyl group may be arbitrarily substituted with a halogen atom, a ring A₁ represents any one of:

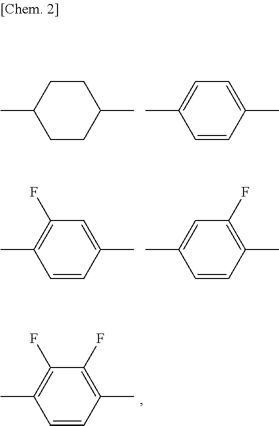

at least one CH₂ group in the ring A₁ may be substituted with an O atom, at least one CH group in the ring A₁ may be substituted with a N atom, and at least one H atom in the ring A₁ may be substituted with Cl, CF₃, or OCF₃.

In the liquid crystal element, an active element using a transparent electrode may be provided on one or both of the pair of substrates configuring the liquid crystal element, and a driving display of a VA mode may be performed.

In the liquid crystal element, a polymerizable compound is cured in a state where a liquid crystal composition including the polymerizable compound is interposed between a pair of substrates, and the liquid crystal composition and a polymer of the polymerizable compound are formed between the pair of substrates.

The compound of General Formula (1) is selected from the following formulae.

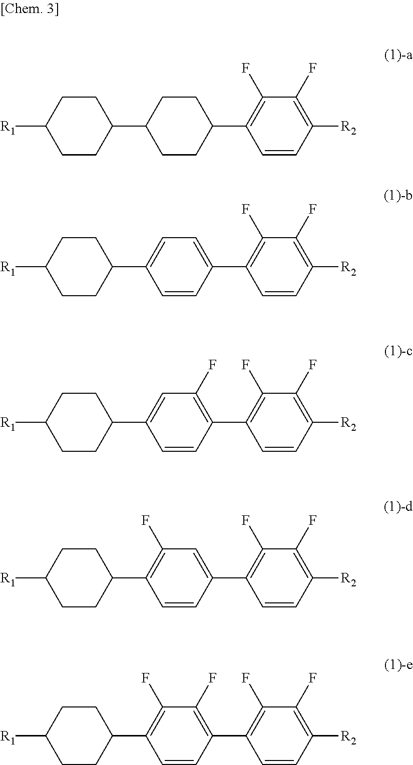

The compound of General Formula (1) is preferably selected from the following formulae, and

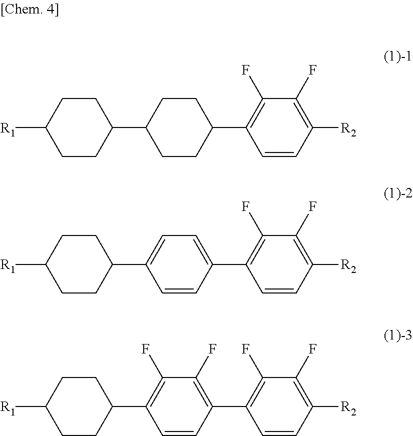

is more preferably a compound in which —R₂ is —O—R₂₁ and the number of carbon atoms of R₁ is 1 to 8 (R₂₁ is the same as R₂). More suitable examples thereof are as follows.

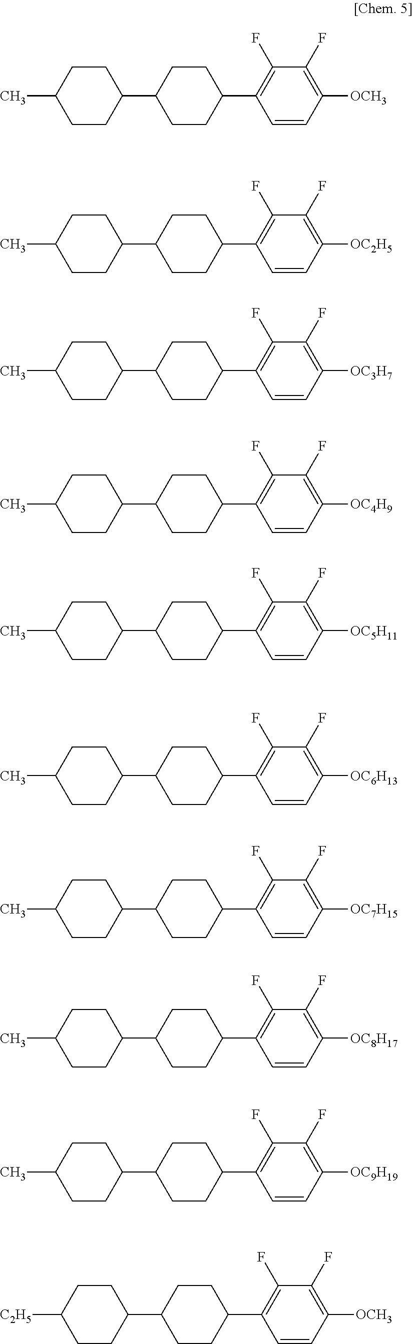

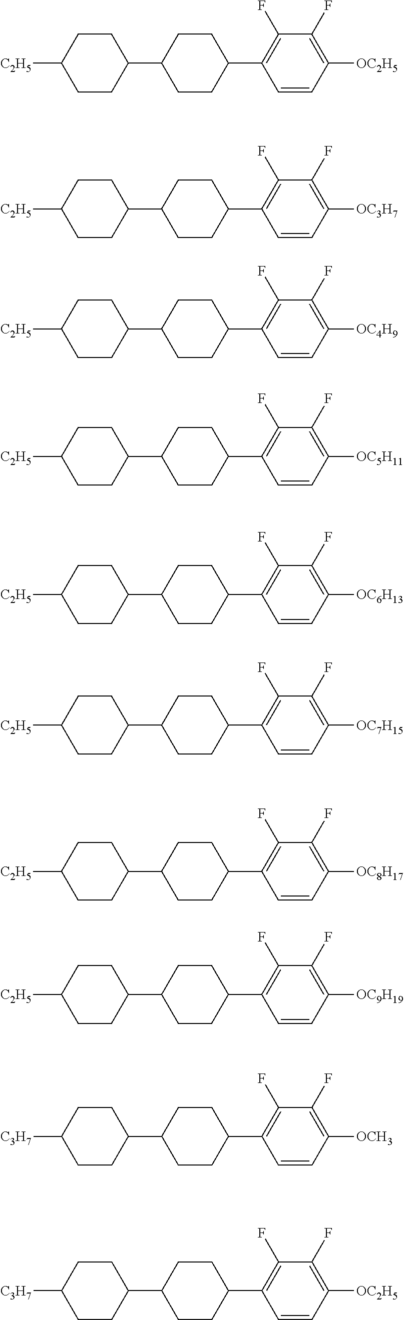

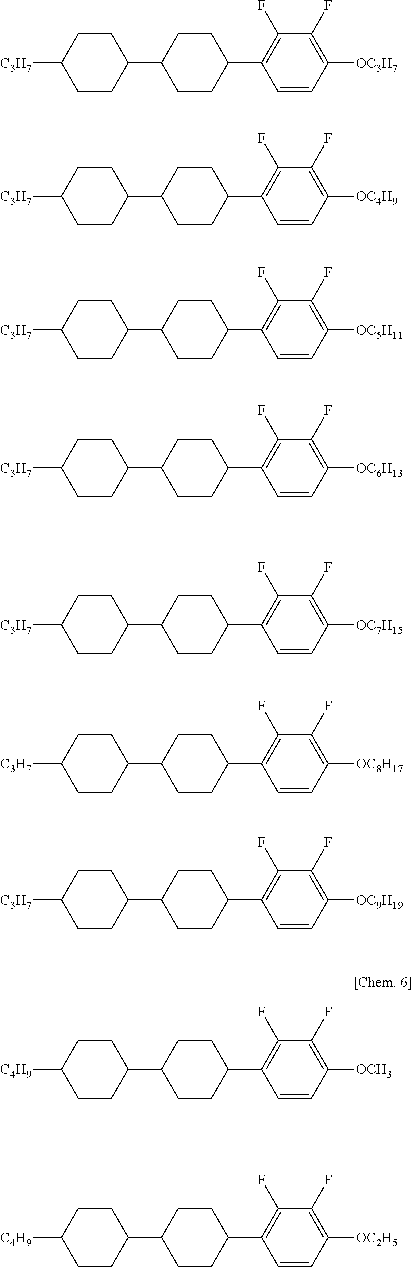

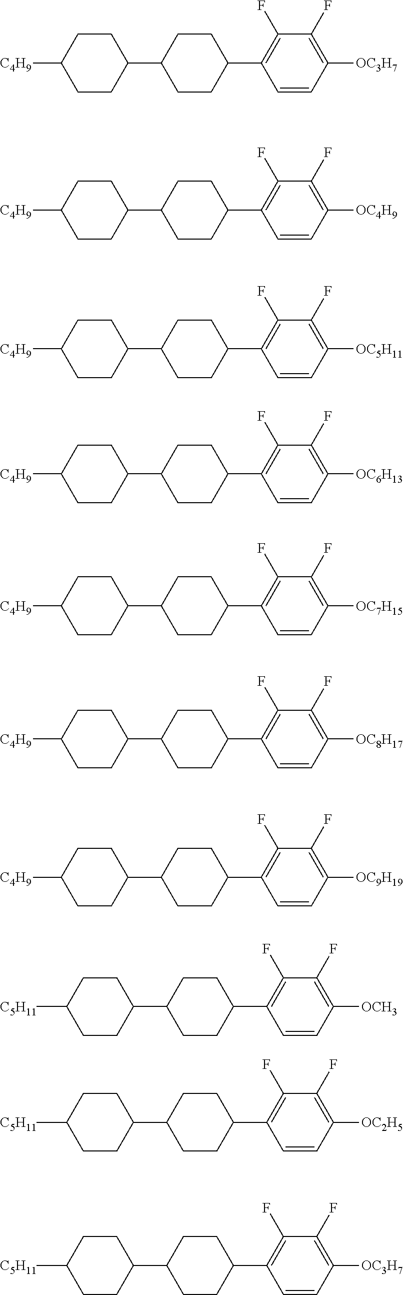

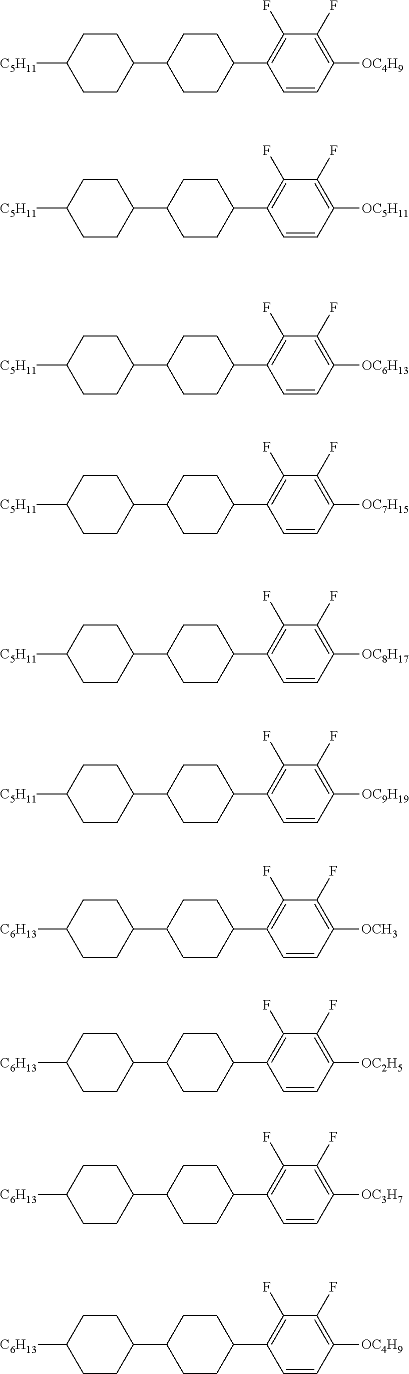

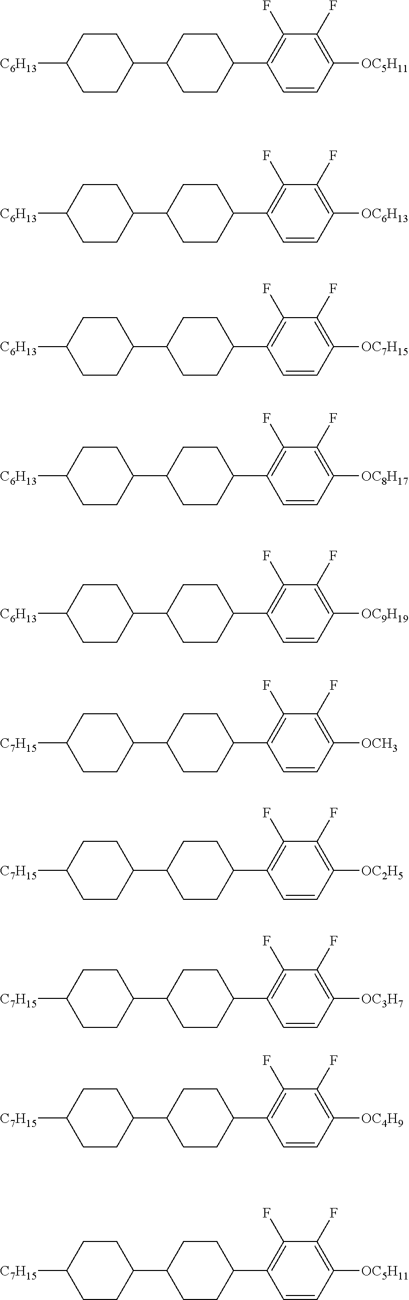

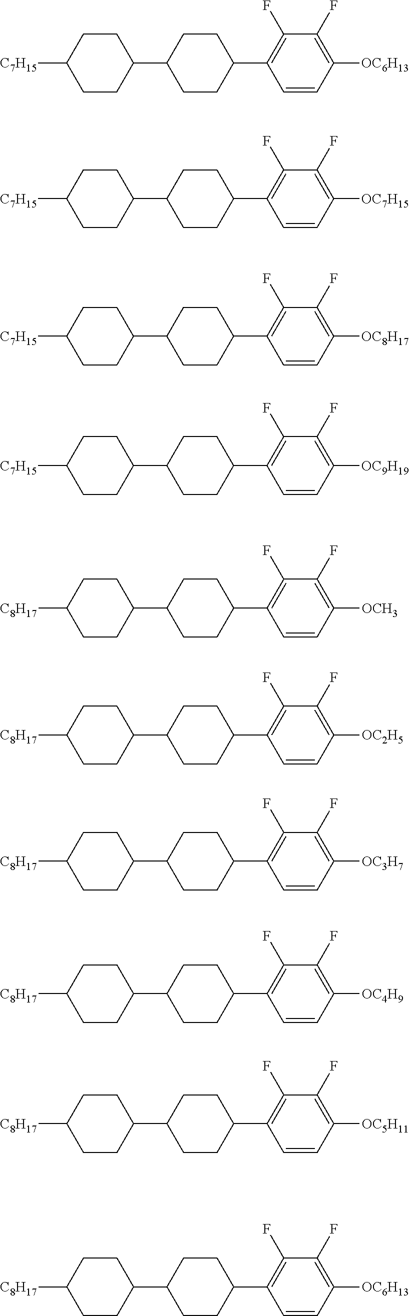

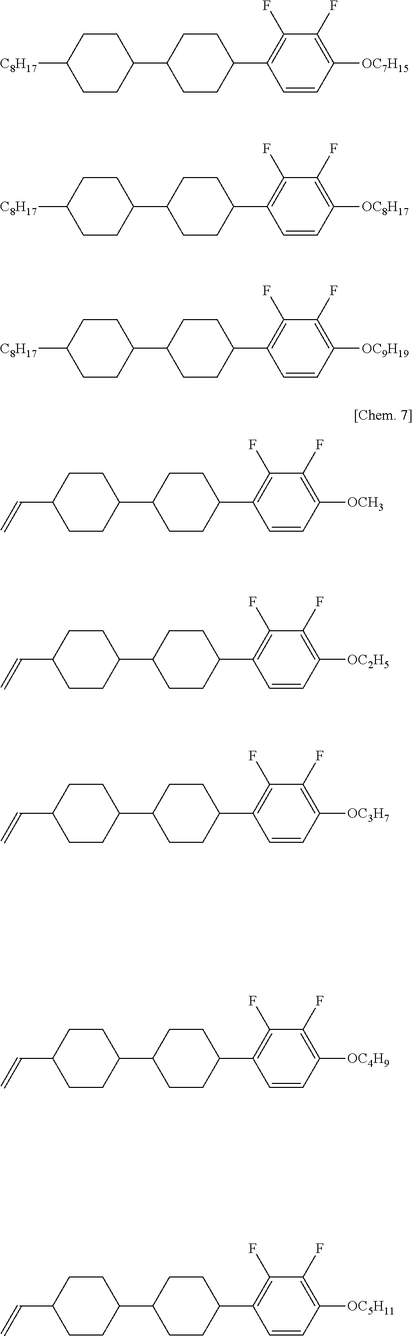

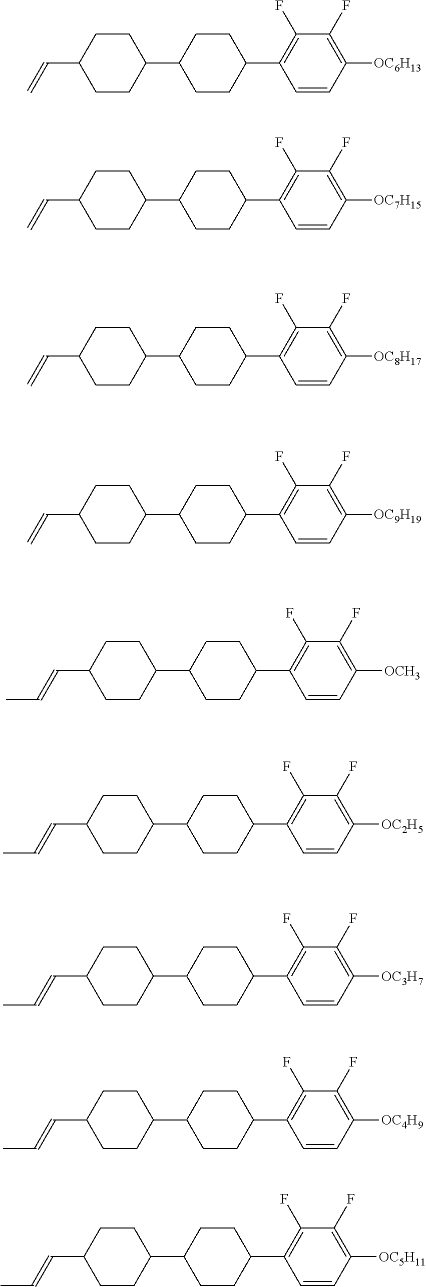

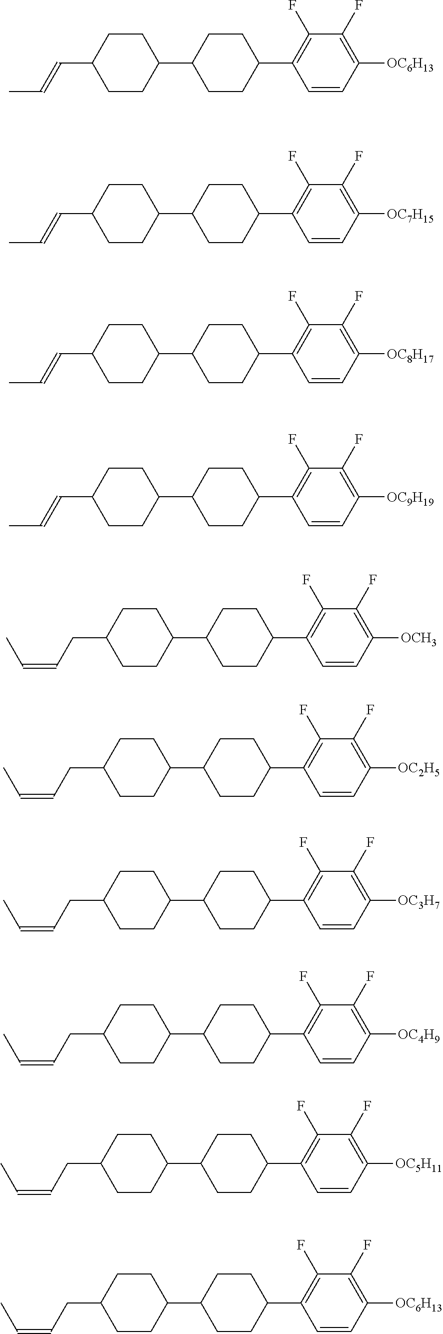

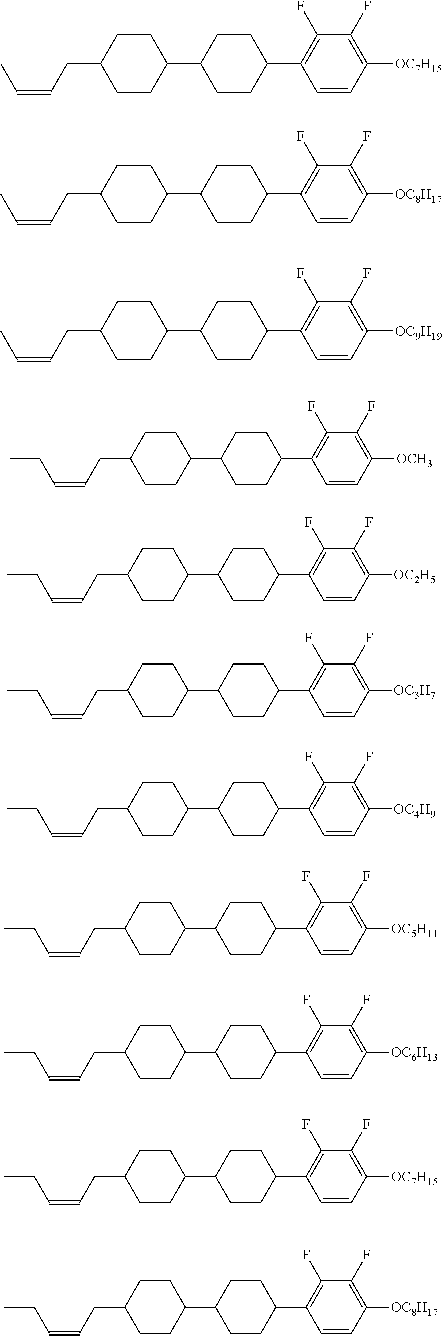

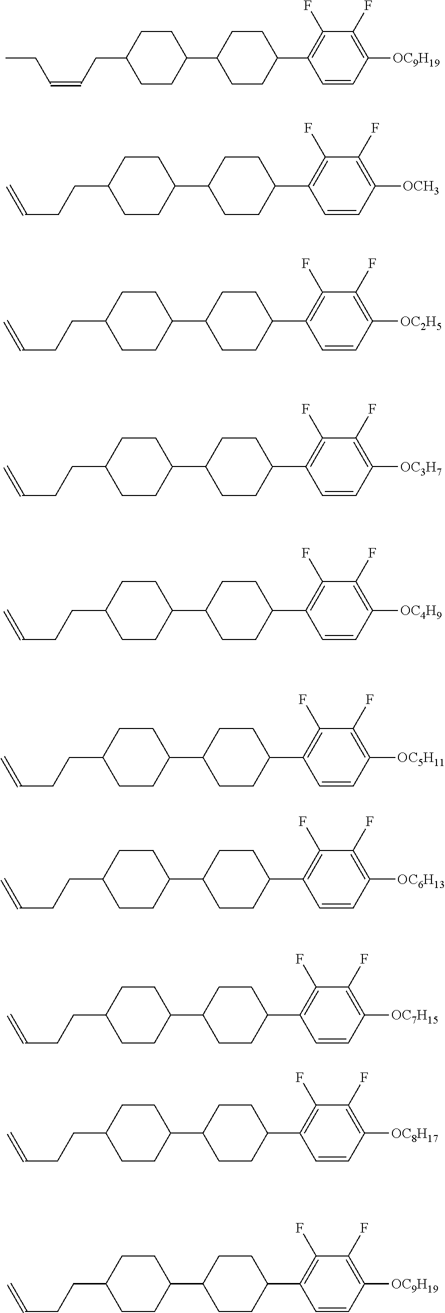

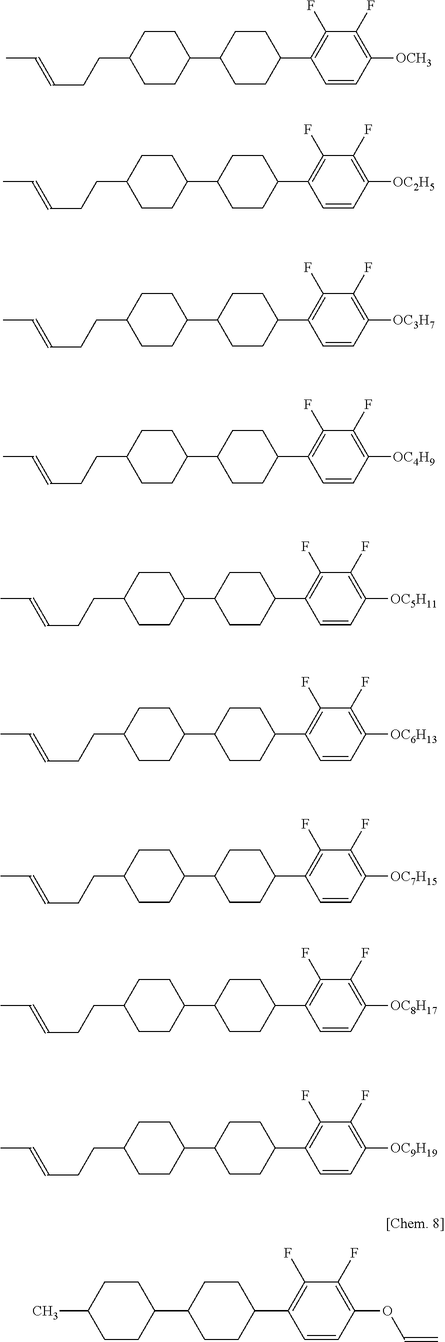

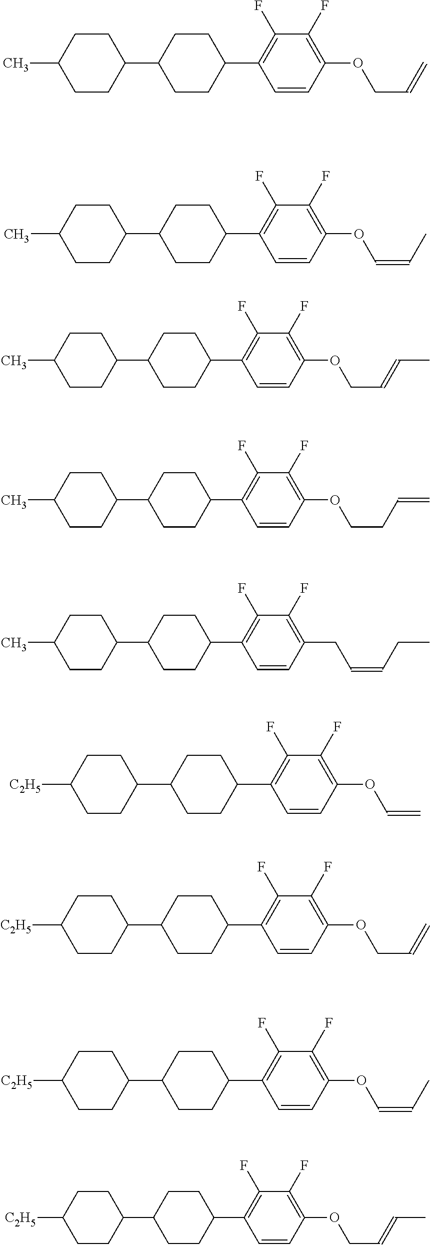

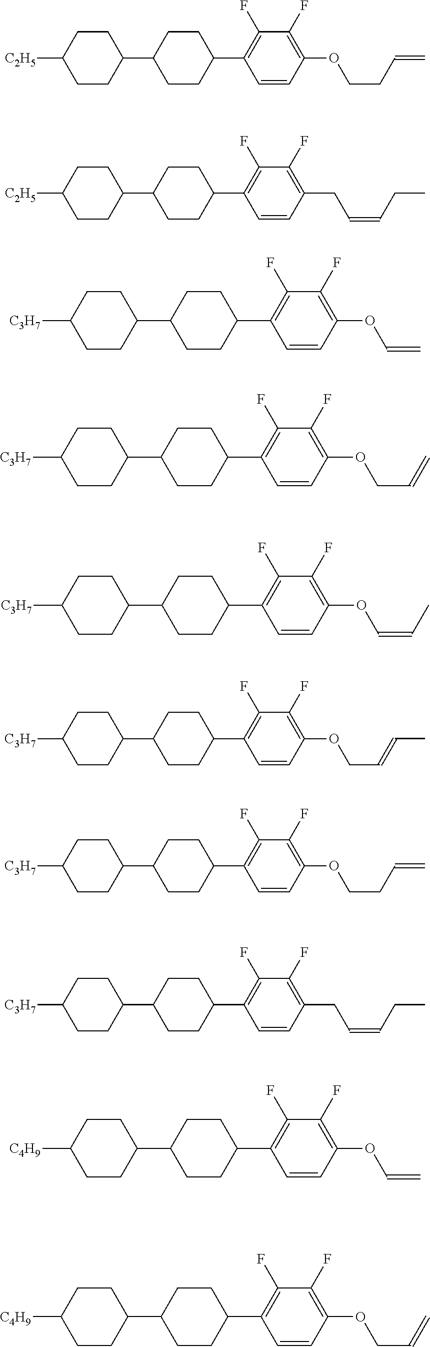

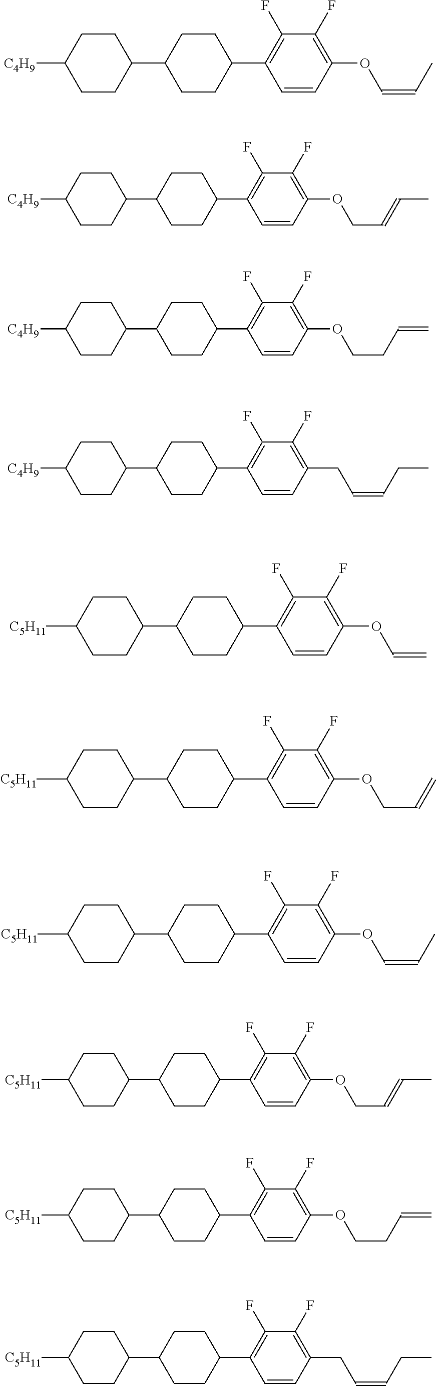

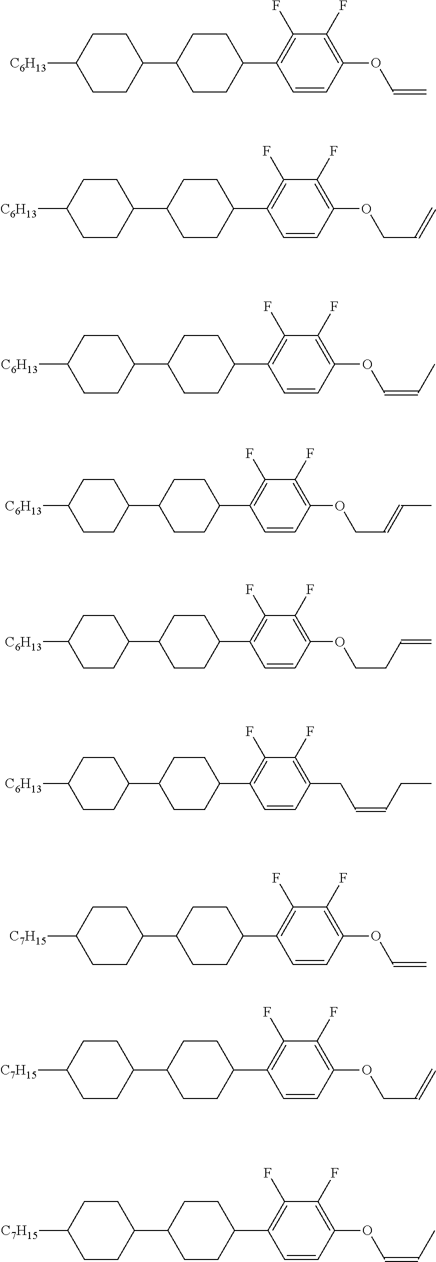

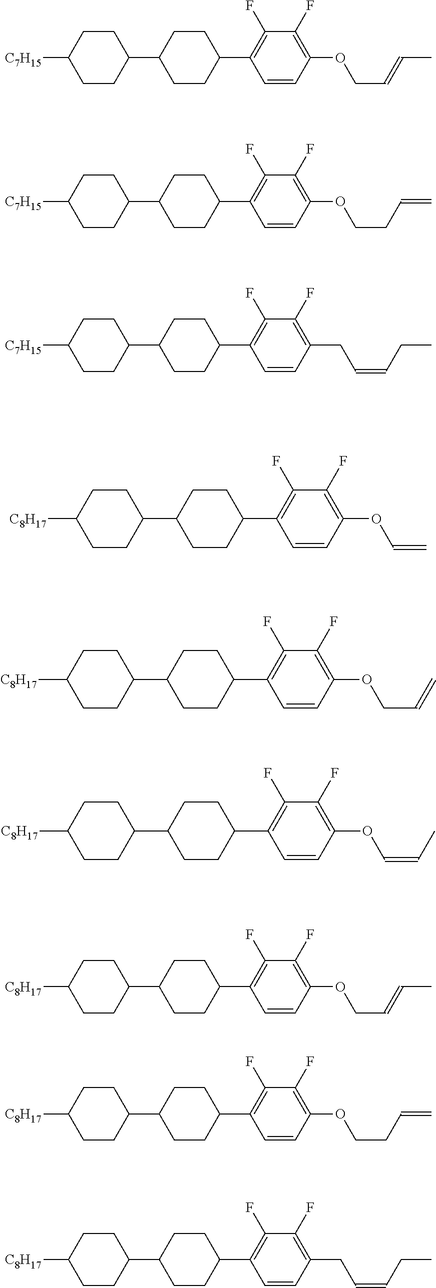

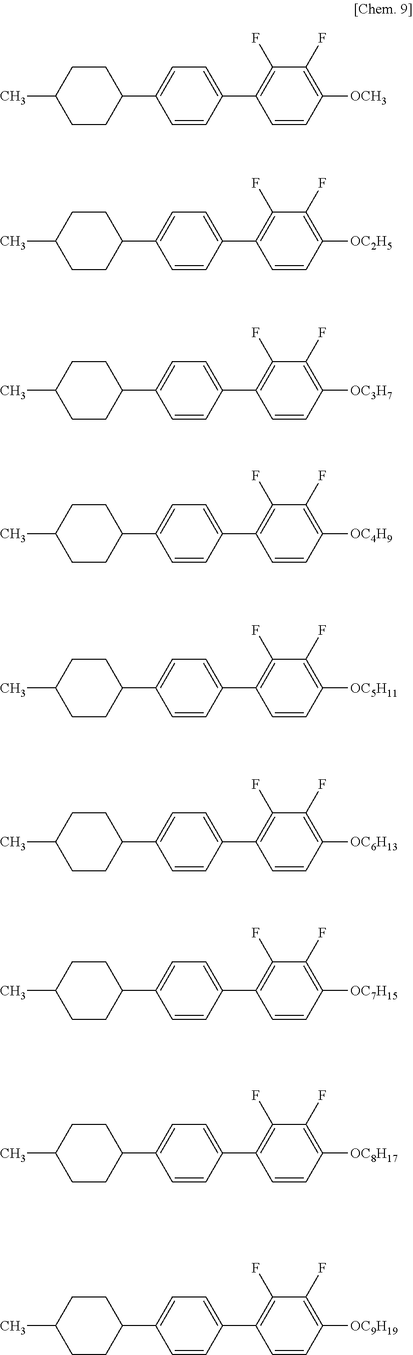

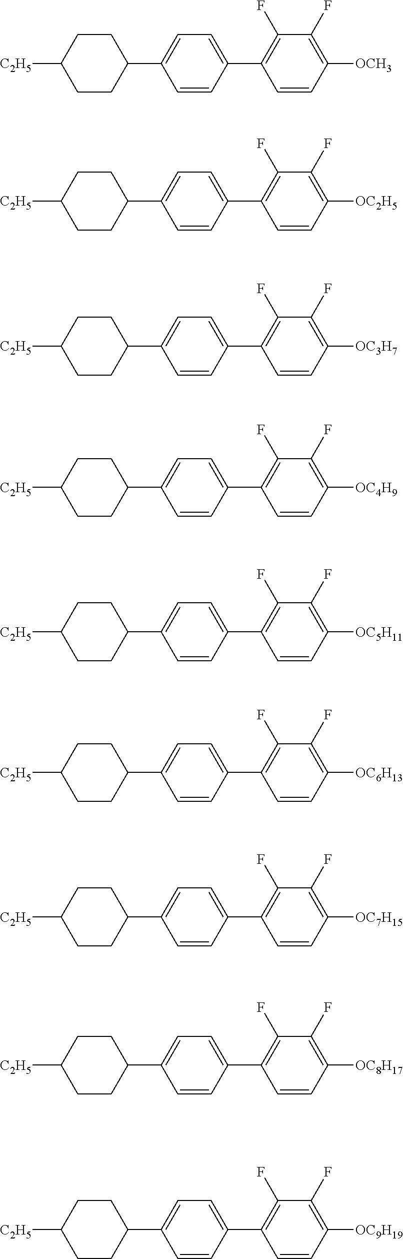

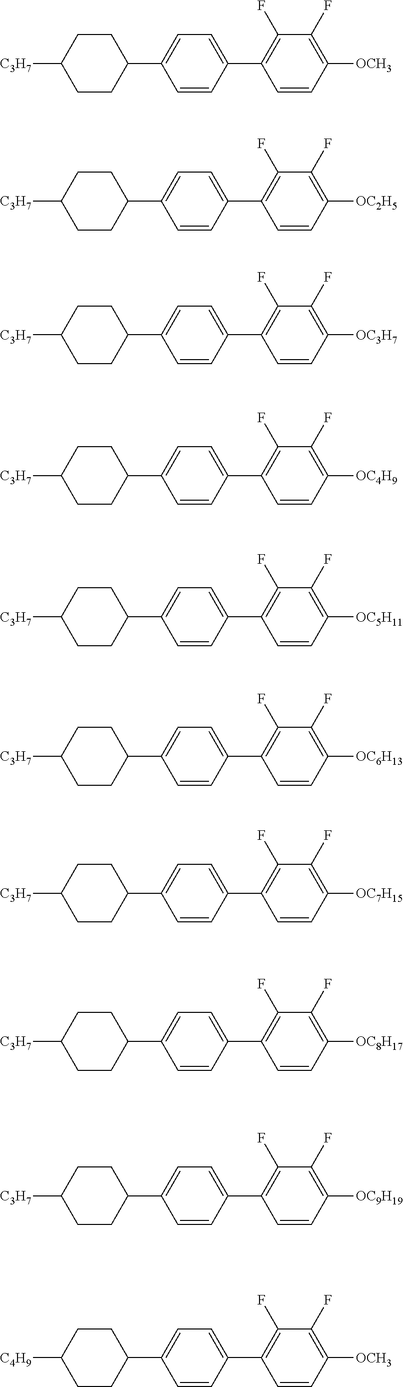

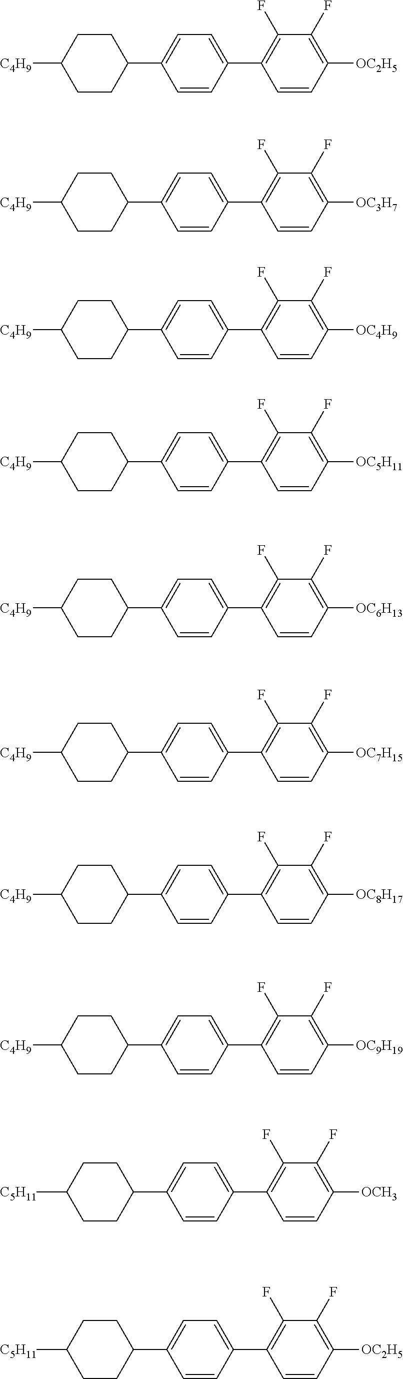

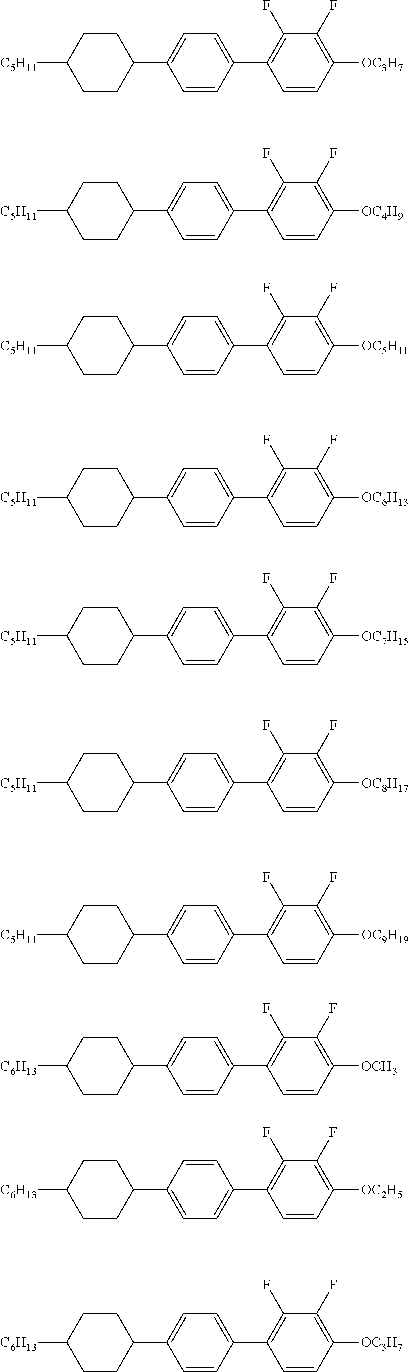

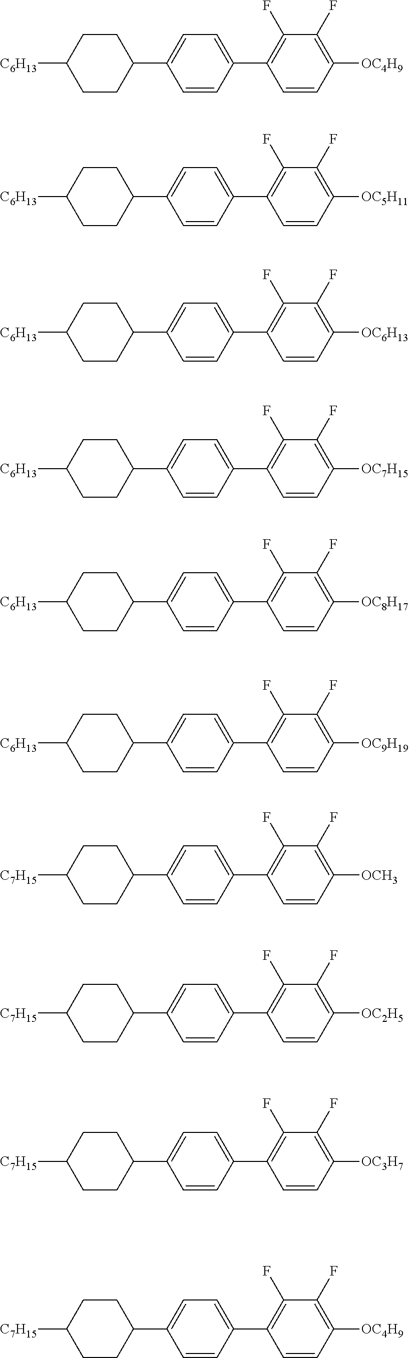

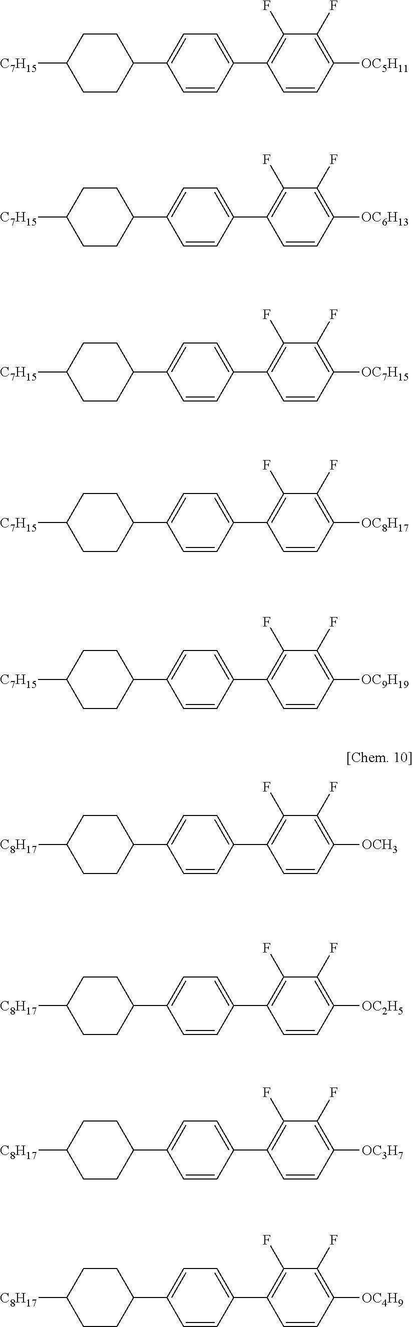

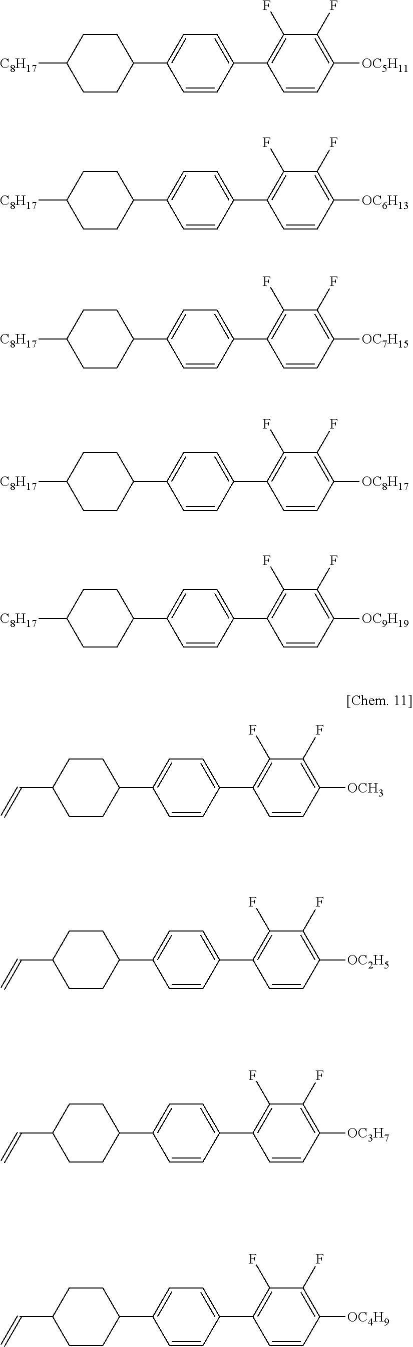

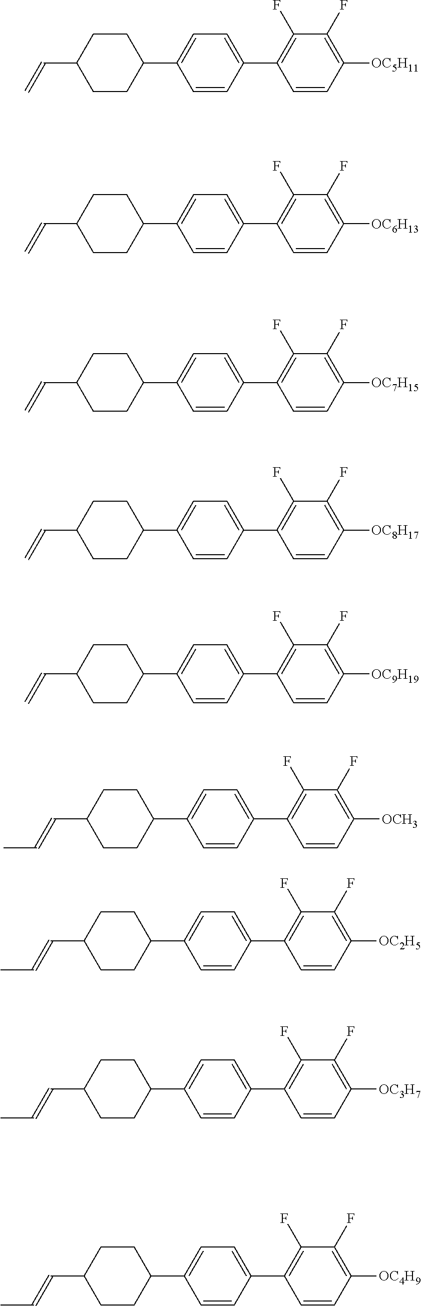

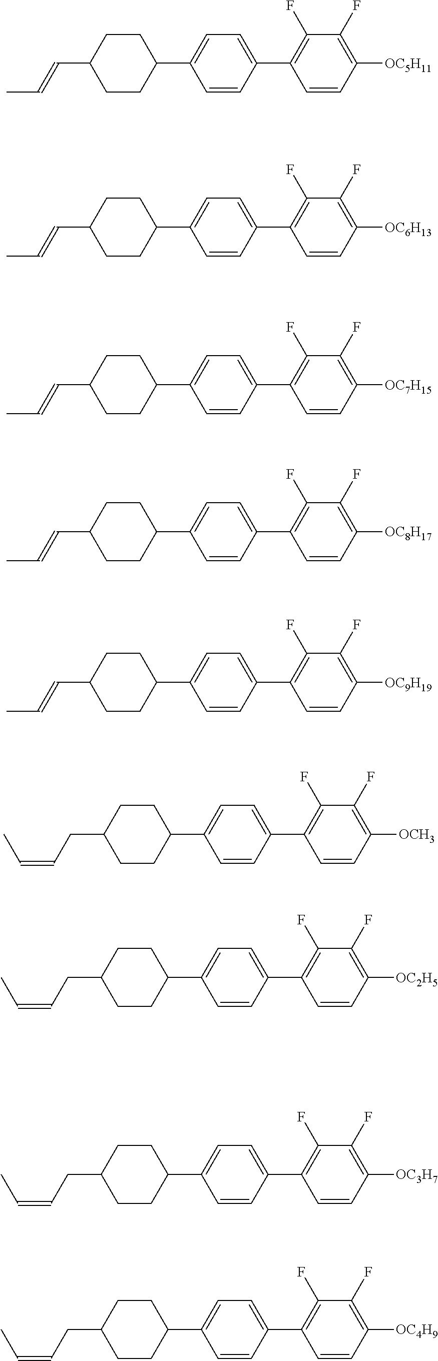

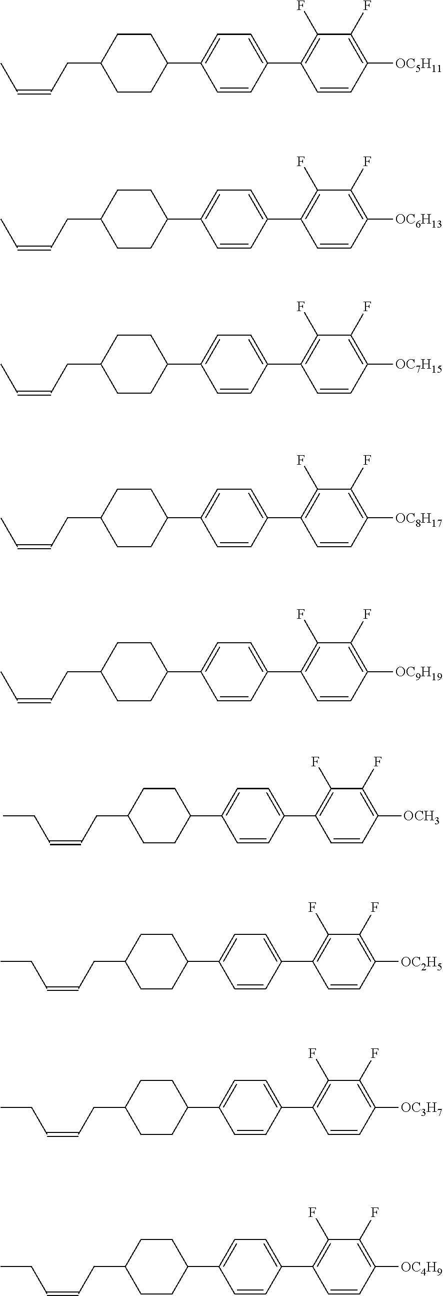

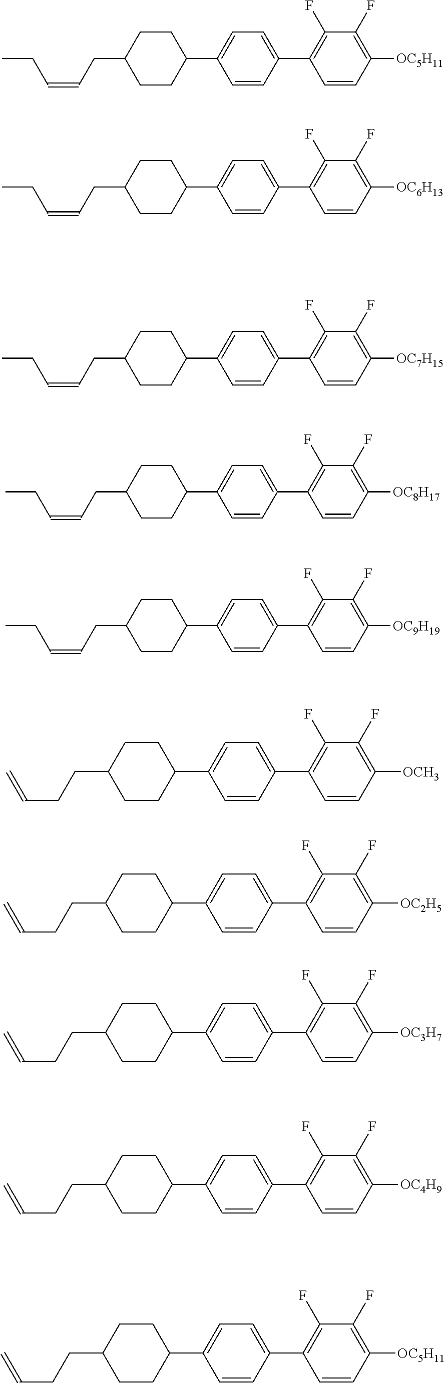

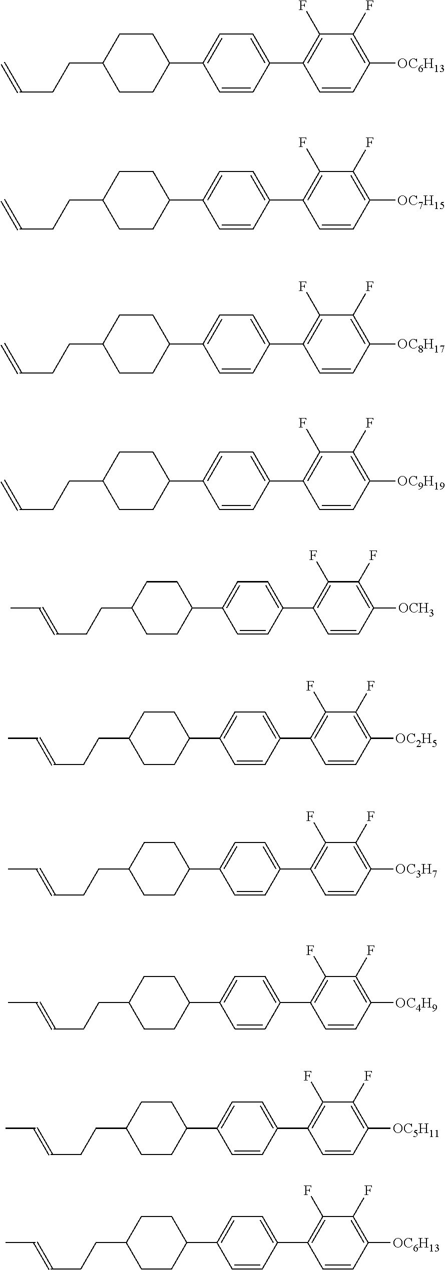

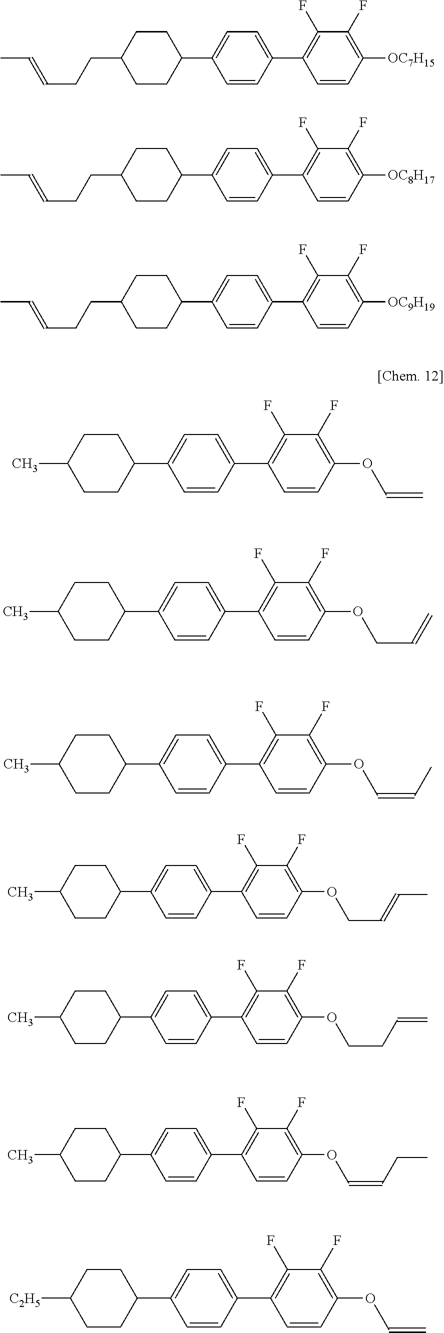

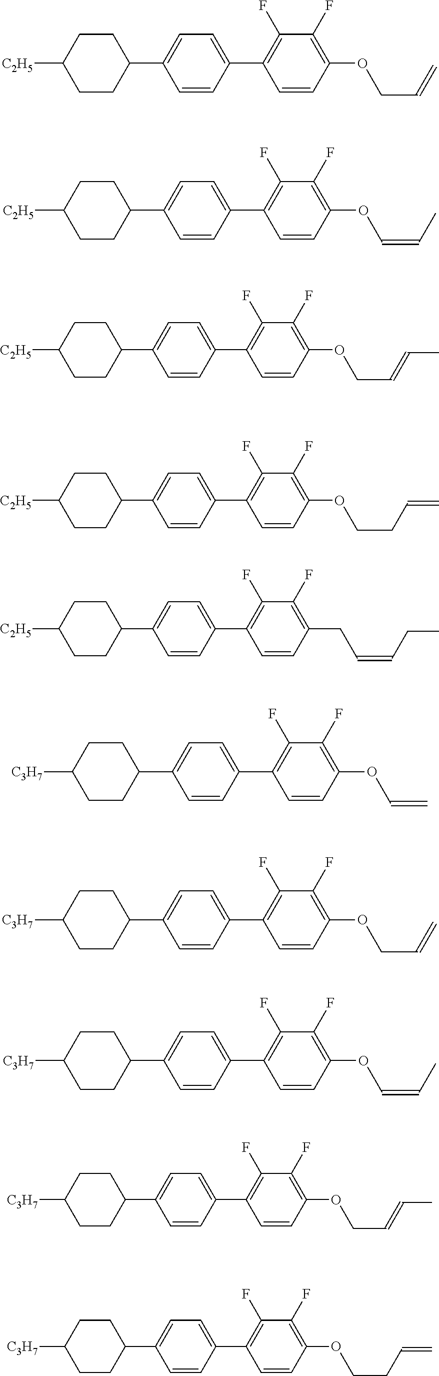

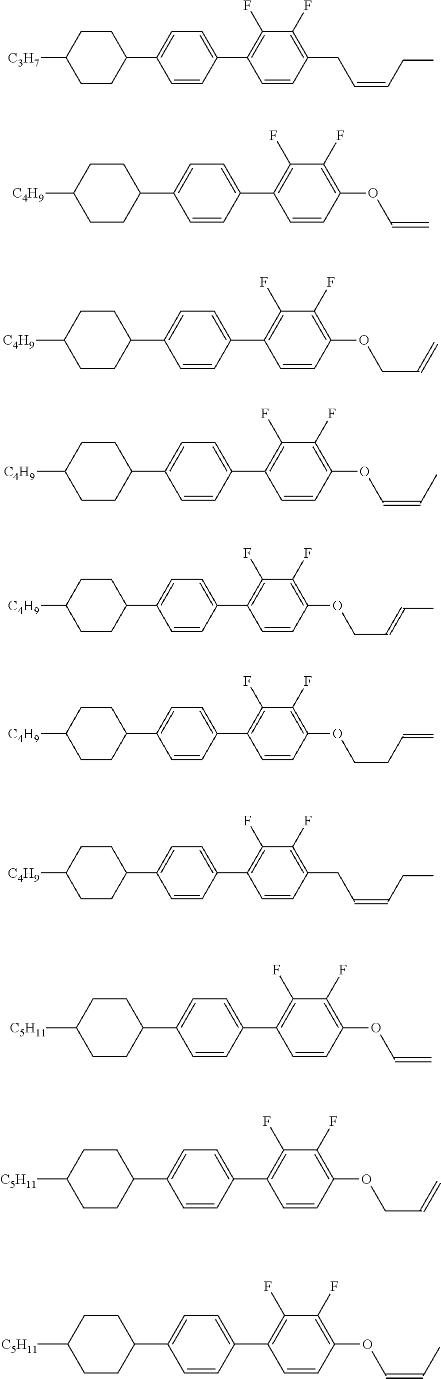

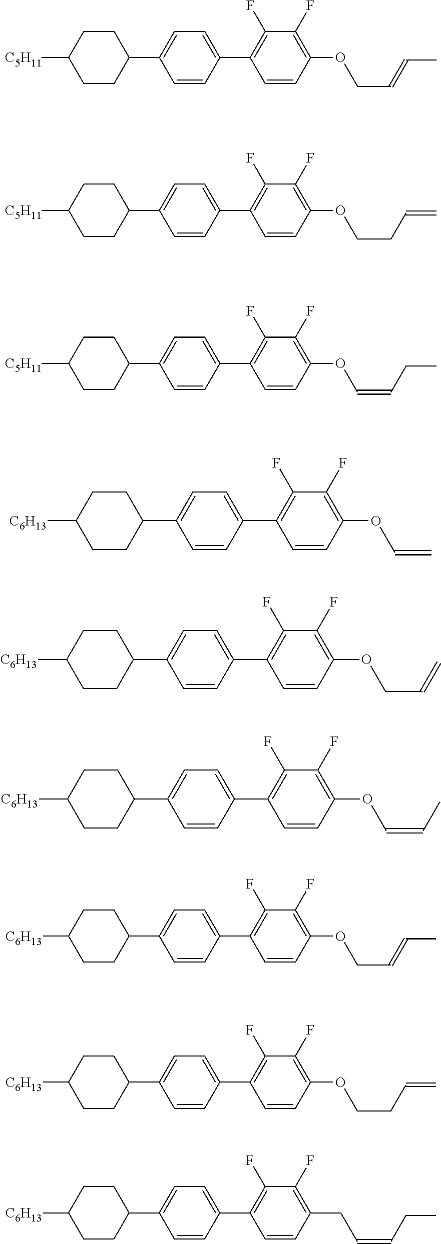

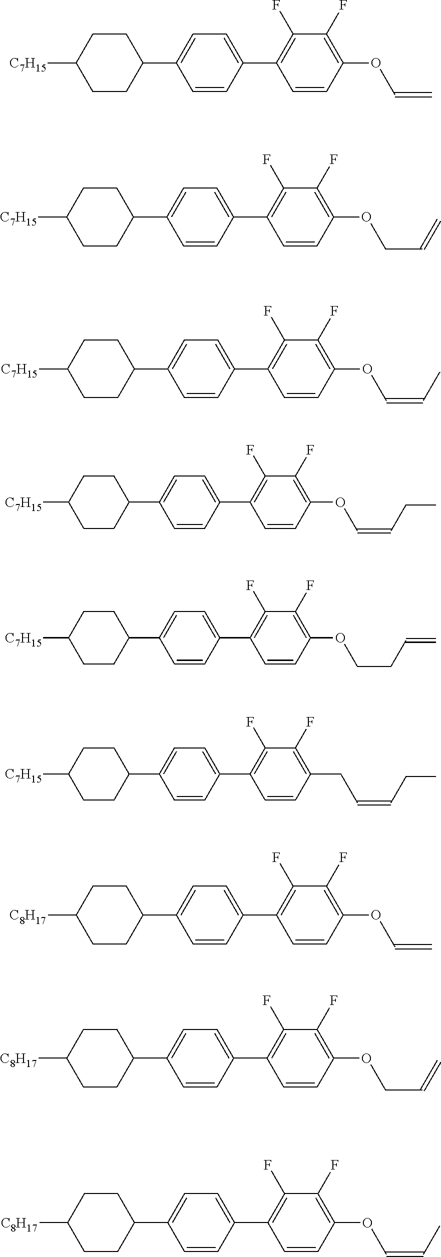

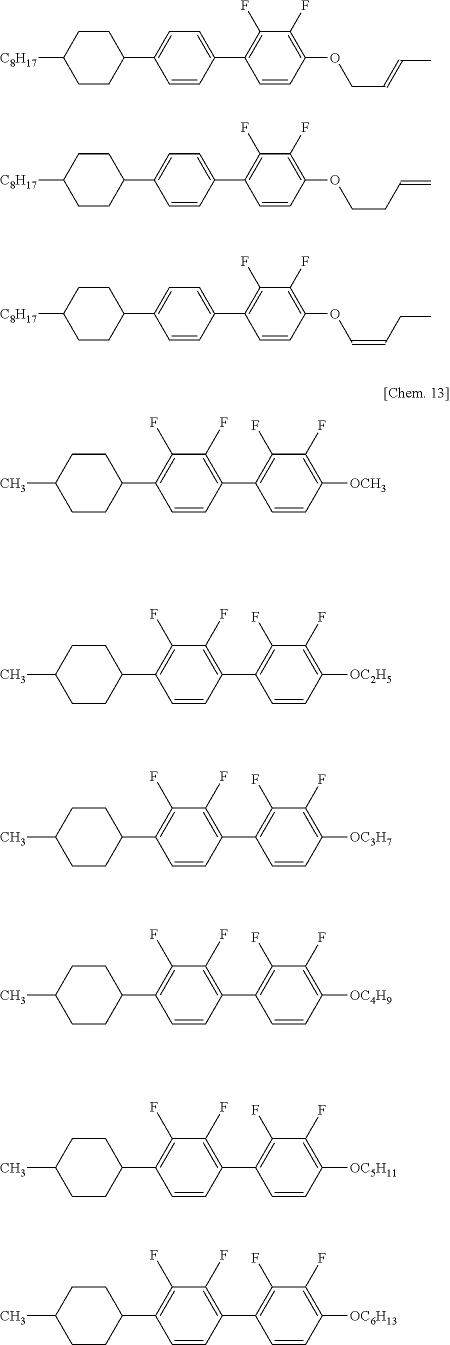

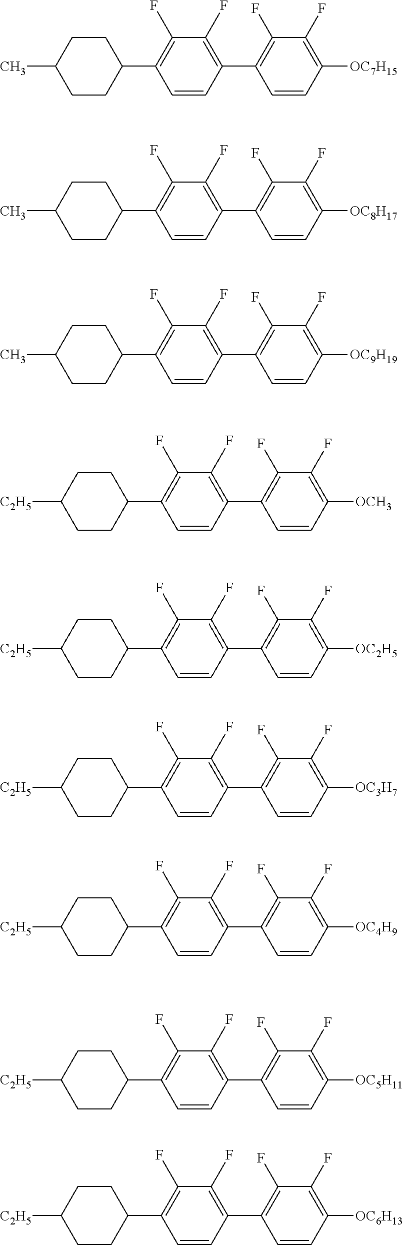

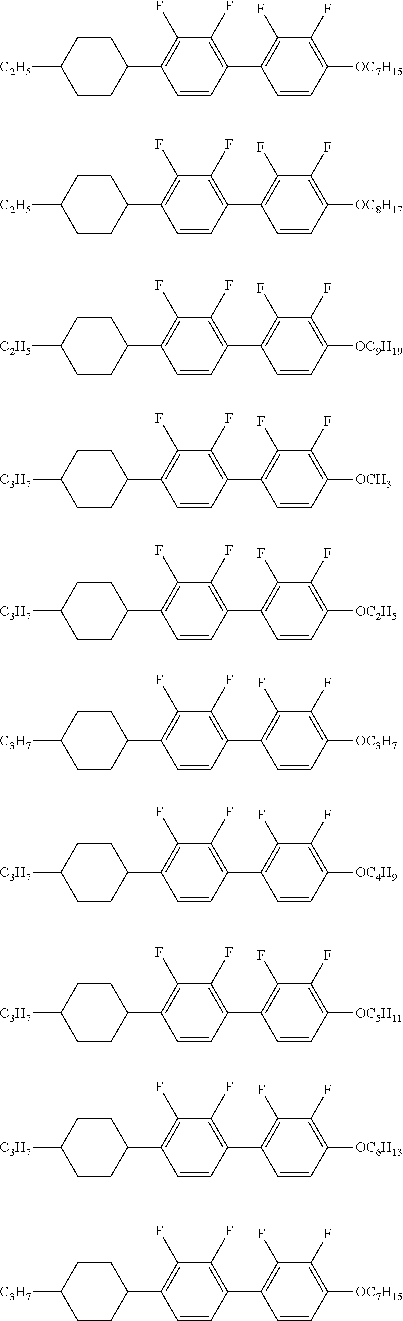

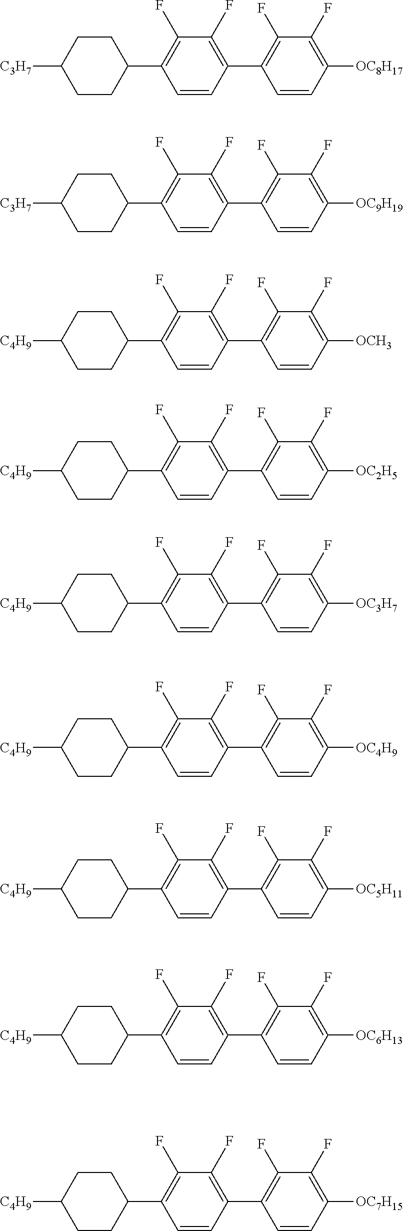

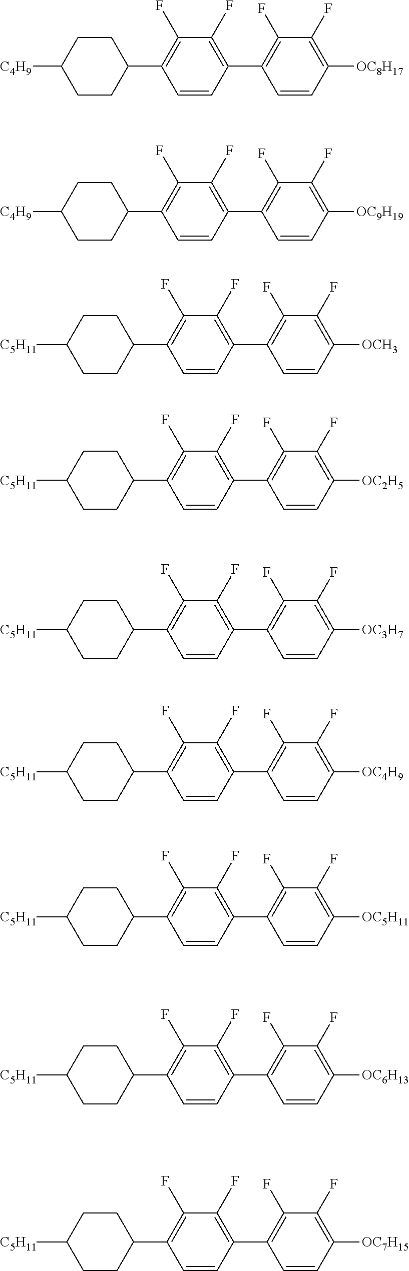

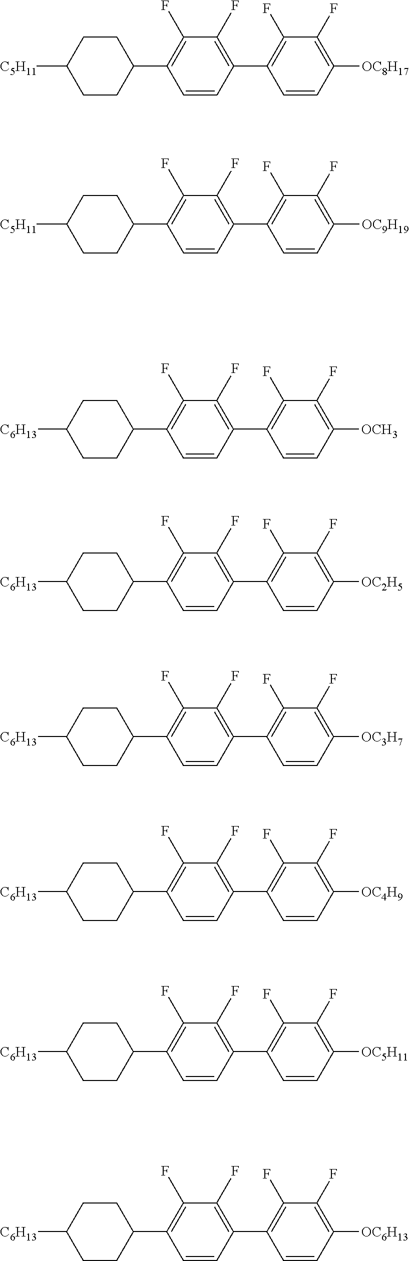

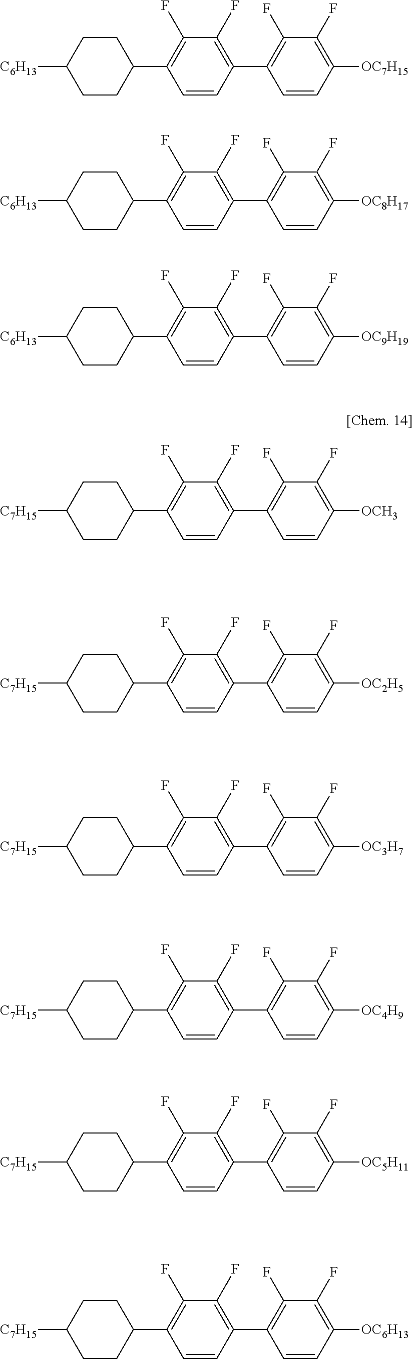

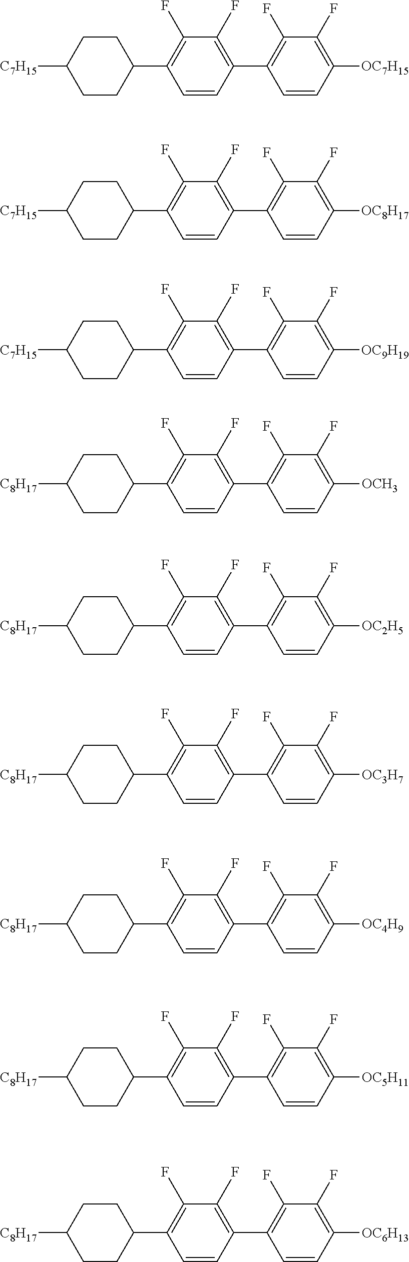

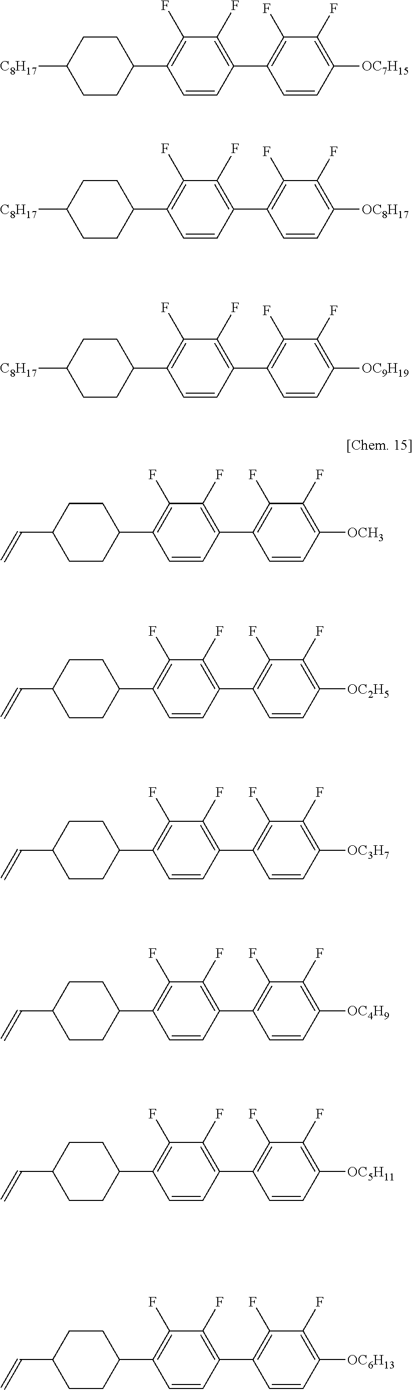

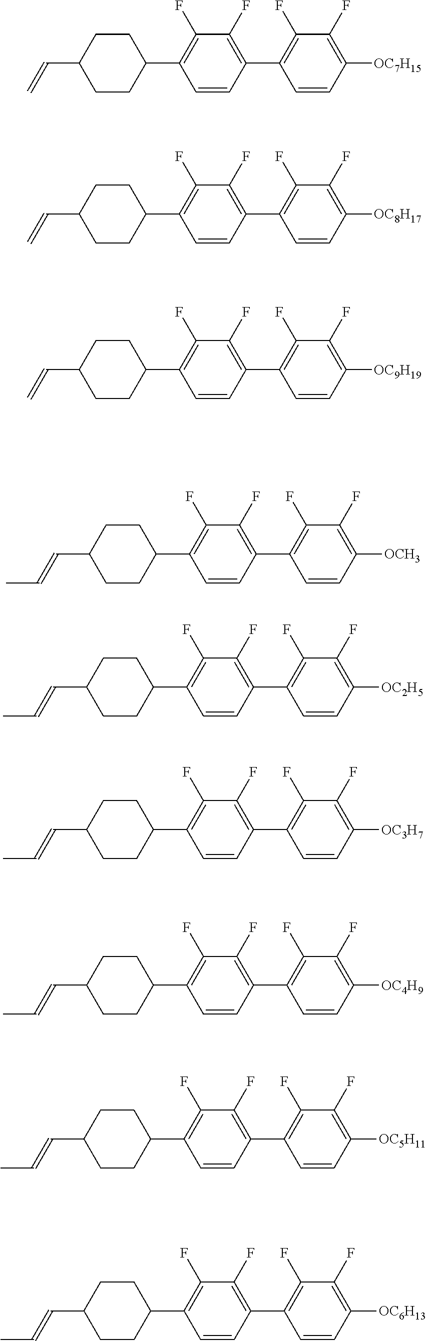

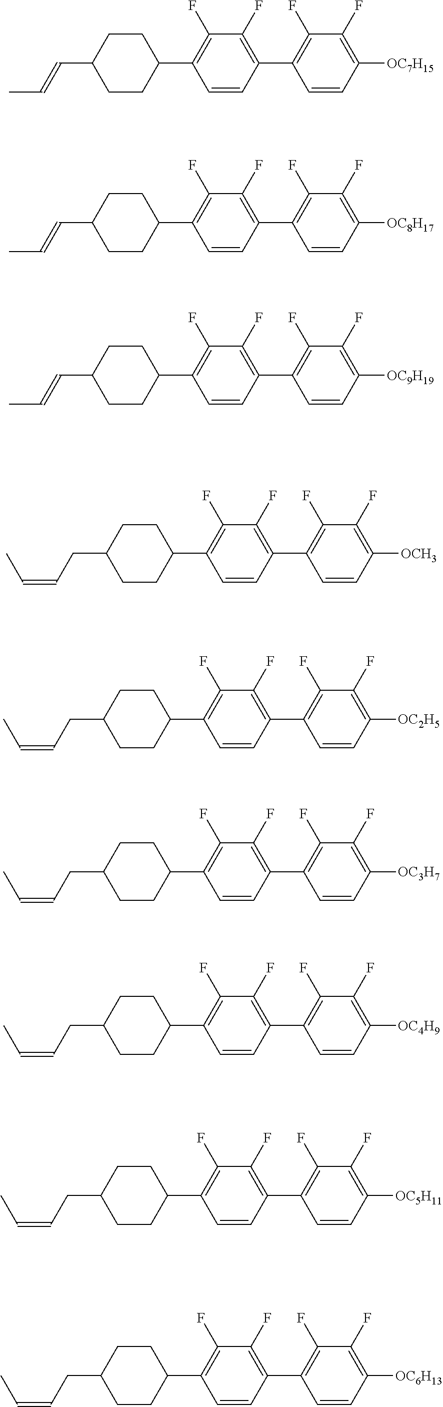

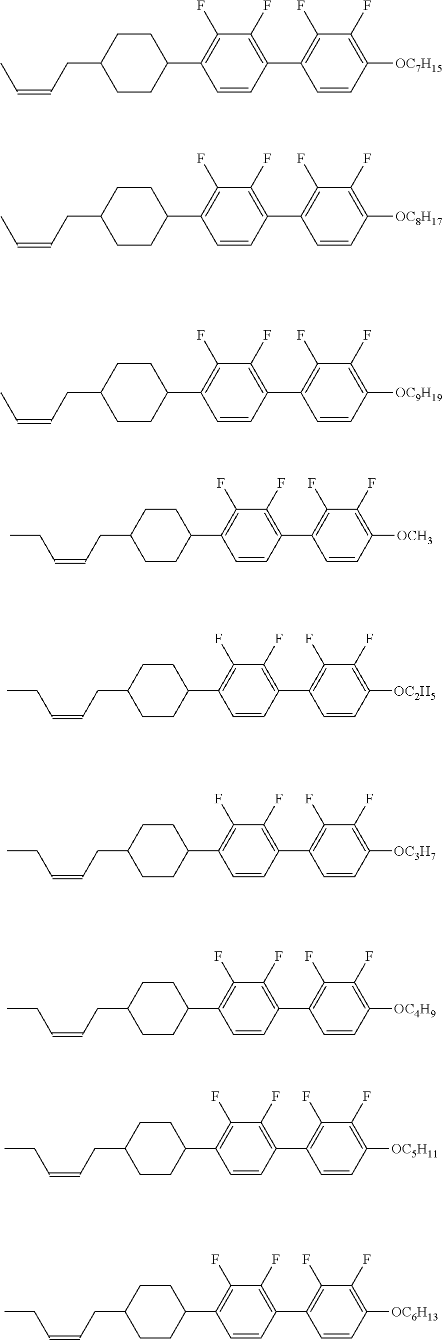

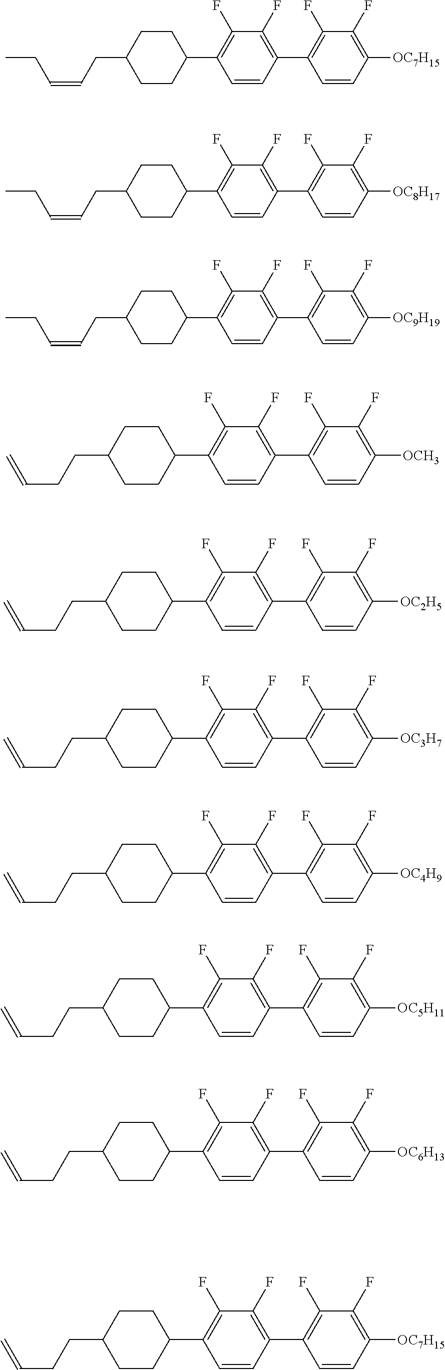

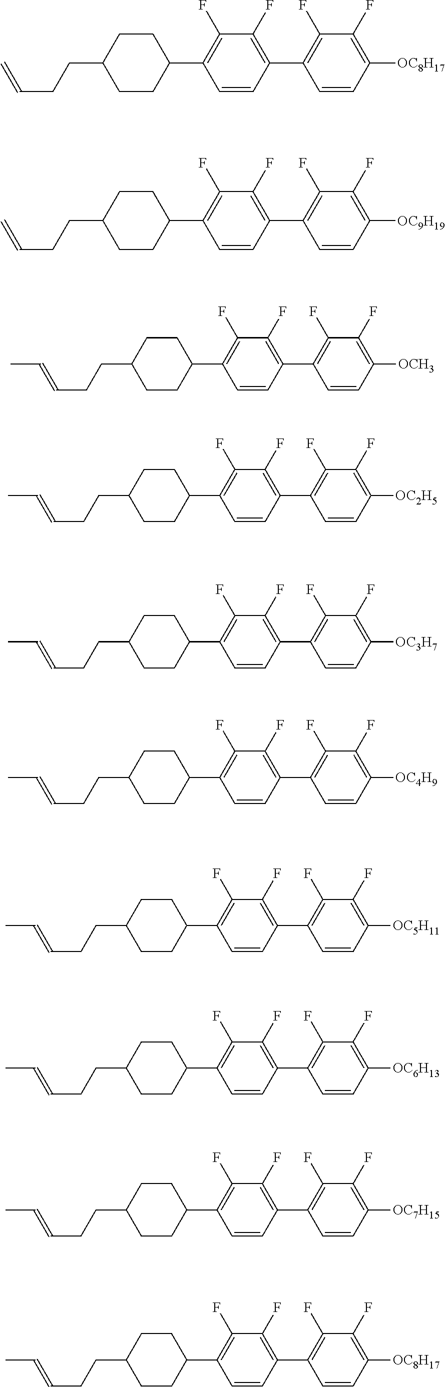

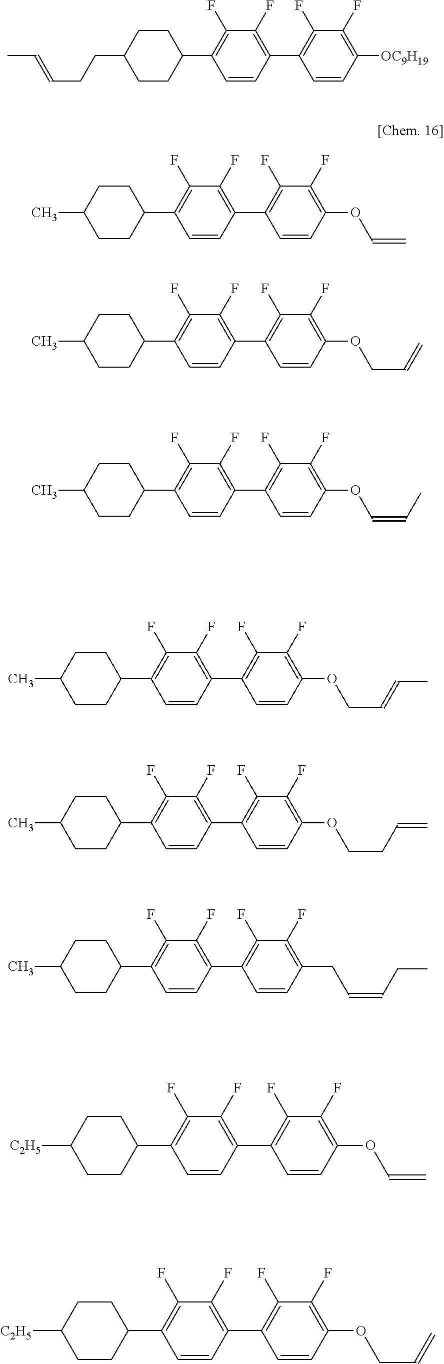

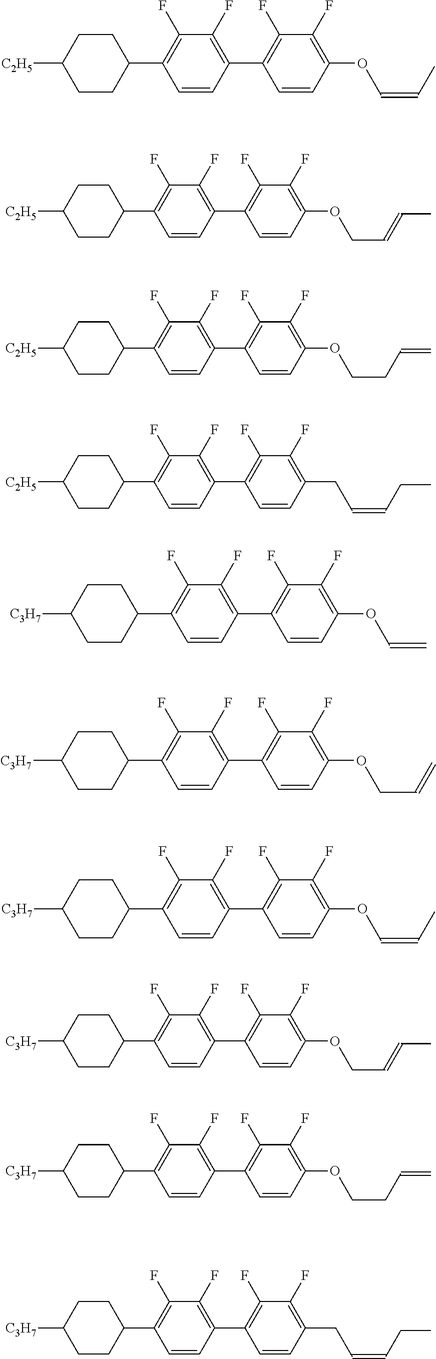

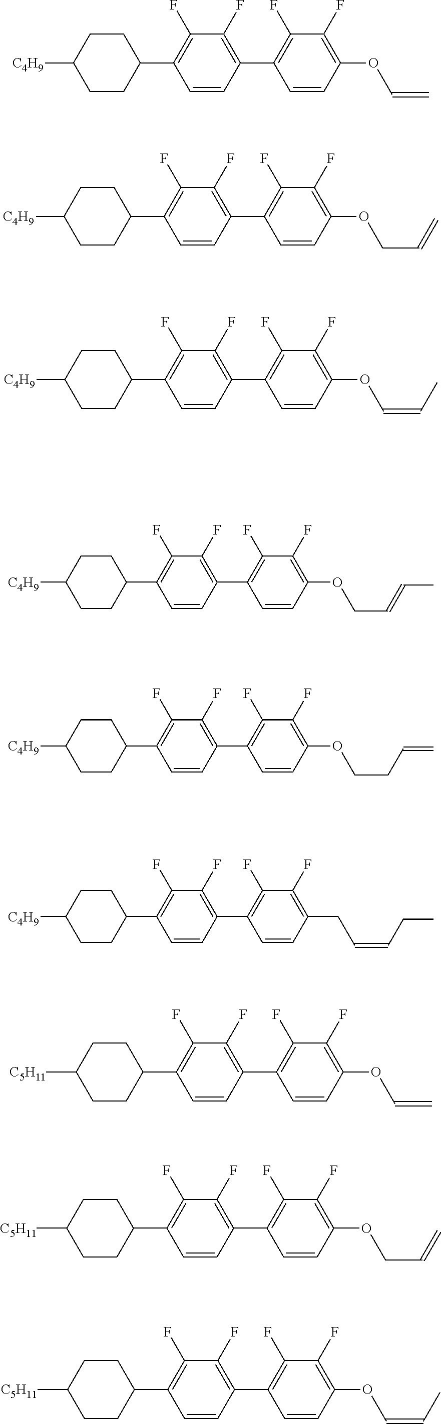

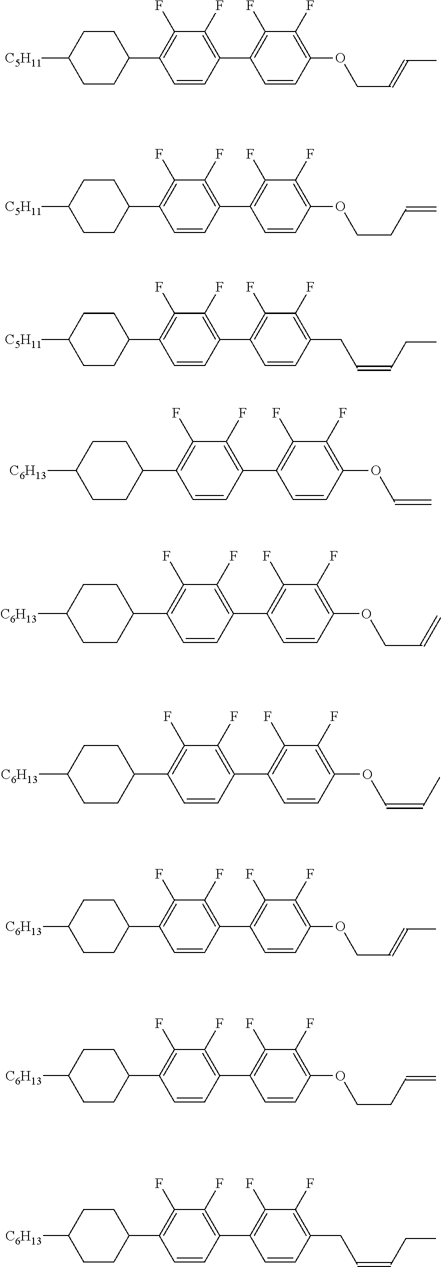

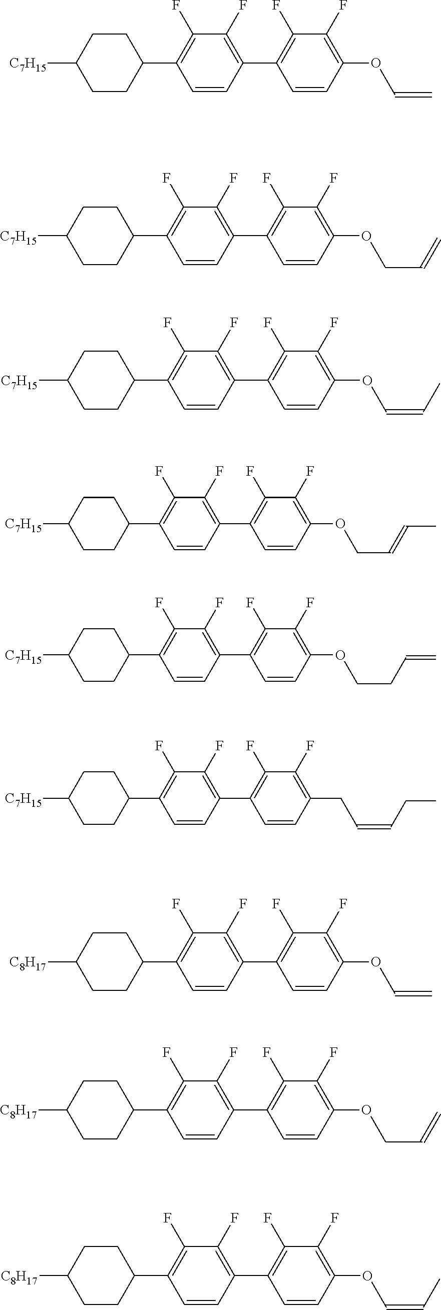

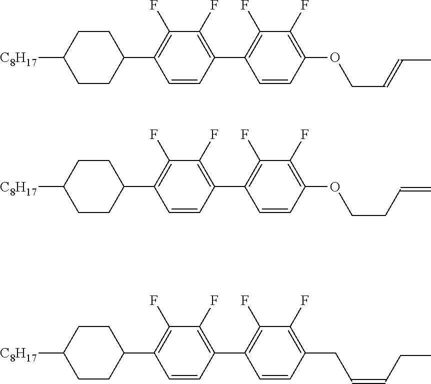

In addition, one or more of compounds represented by General Formulae (2) to (4):

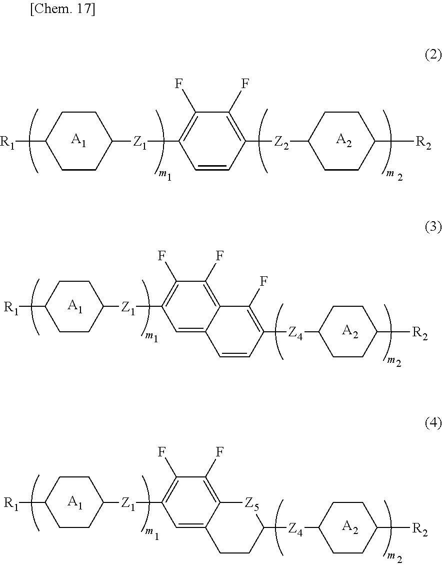

(in the formulae, R₁, R₂, and the ring A₁ are each independently the same as the components described in claim 1, the rings A₂ are each independently the same as the rings A₁, Z₁ to Z₄ each independently represent a single bond, —CH═CH—, —C≡C—, —CH₂CH₂—, —(CH₂)₄—, —COO—, —OCH₂—, —CH₂O—, —OCF₂—, or —CF₂O—, at least one of Z₁ and Z₂ is not a single bond, Z₅ represents a CH₂ group or an O atom, m₁ and m₂ each independently represent 0 to 3, and the sum of m₁+m₂ are each independently 1, 2, or 3) can be included in the liquid crystal composition in the liquid crystal element.

Preferable examples of General Formula (2) include compounds represented by the following formulae.

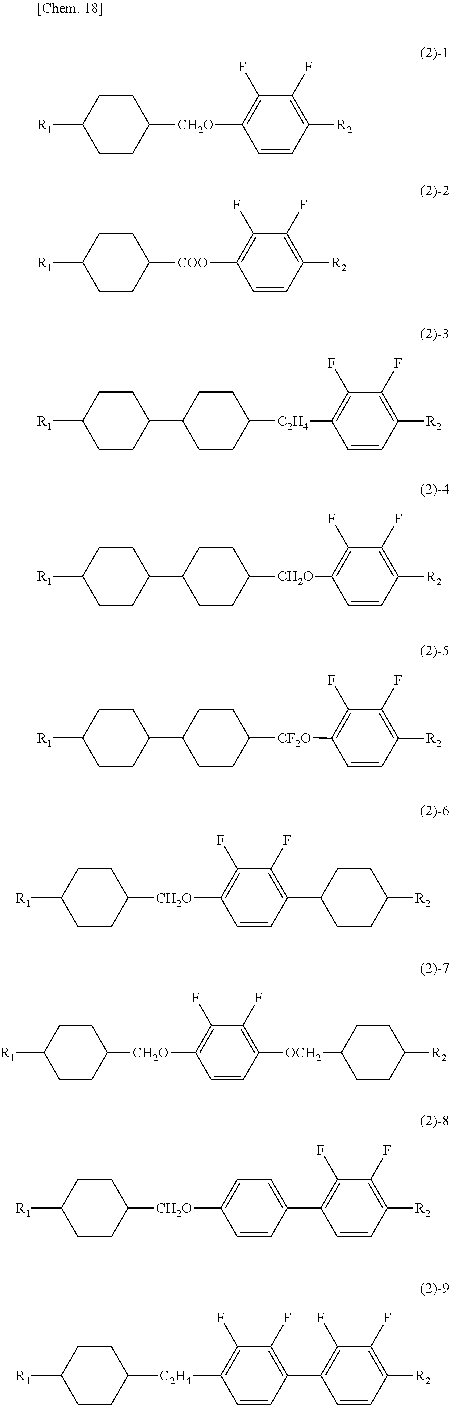

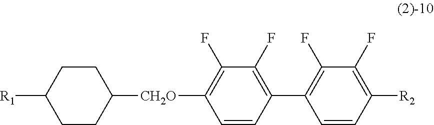

More preferable examples thereof include compounds represented by:

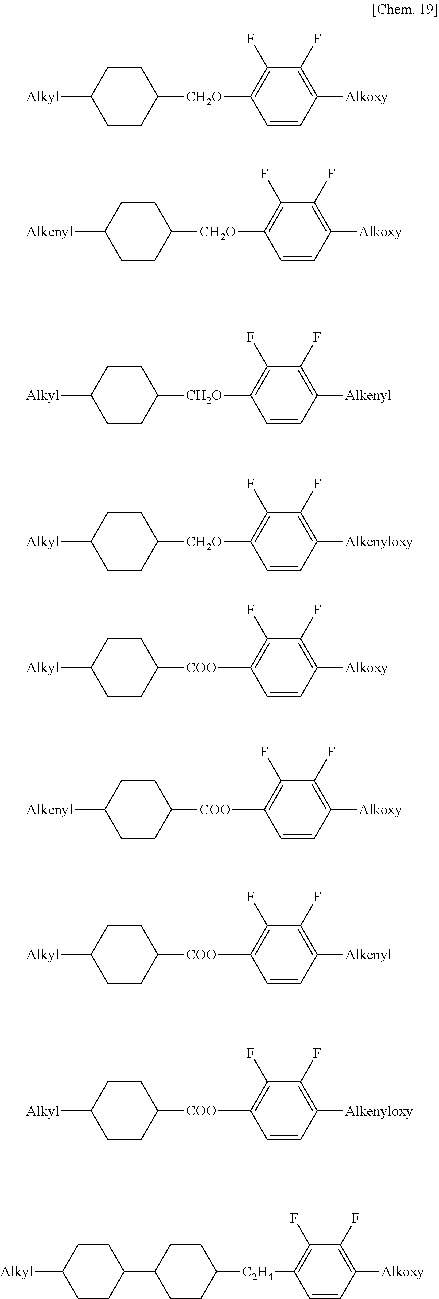

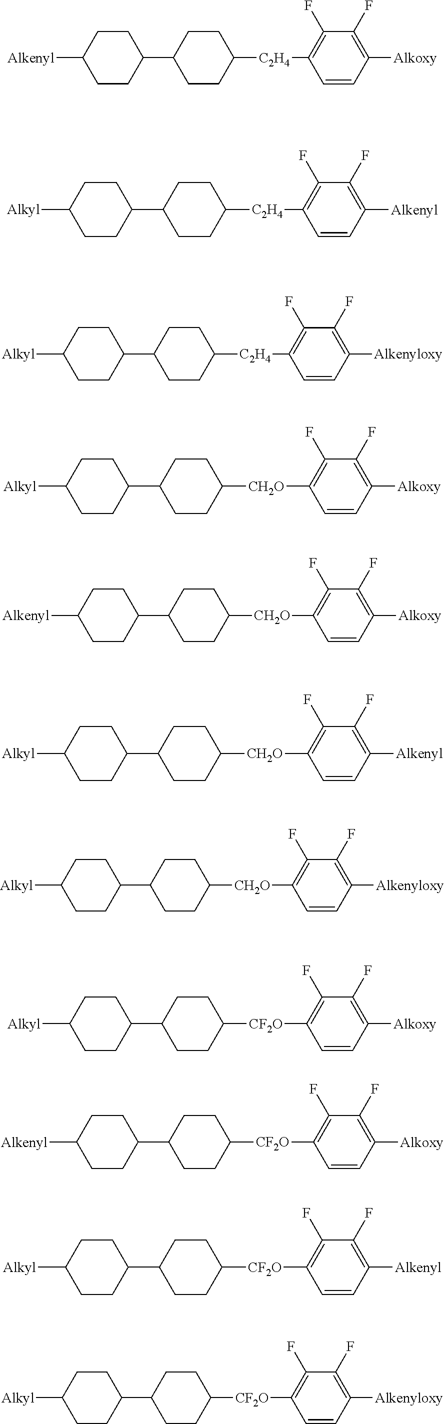

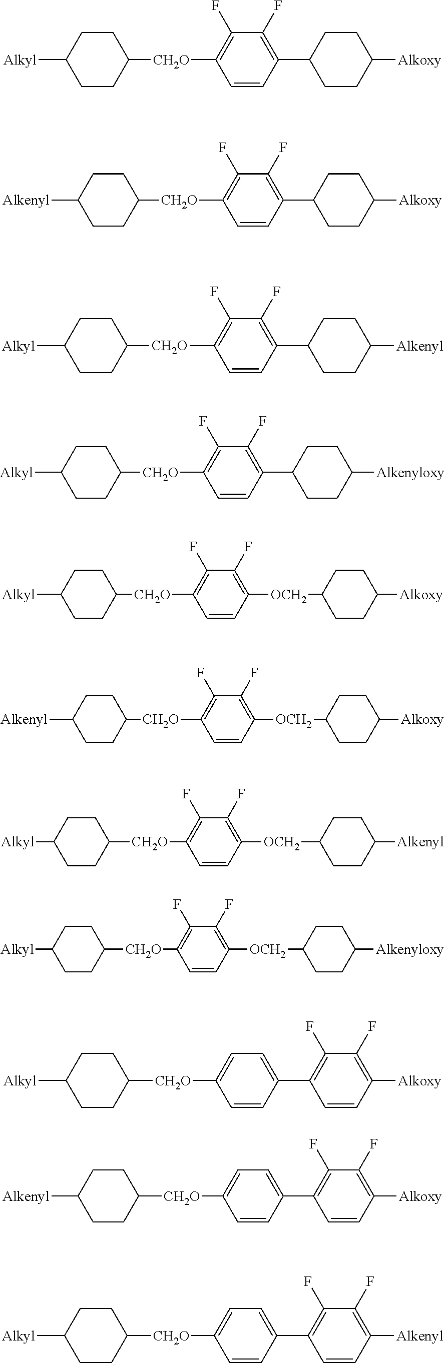

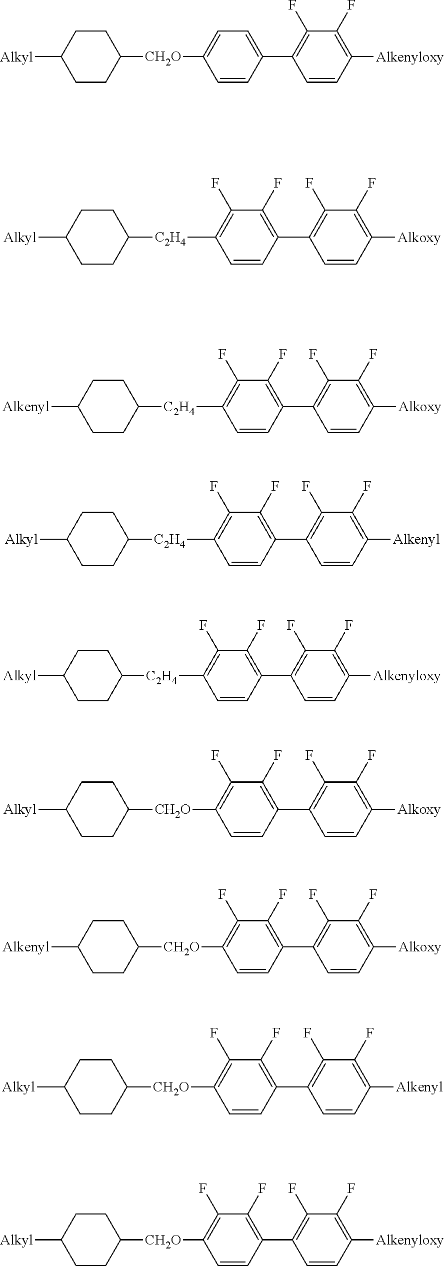

(in the formulae, Alkyl's each independently represent an alkyl group having 1 to 8 carbon atoms, Alkoxy's each independently represent an alkoxy group having 1 to 8 carbon atoms, Alkenyl's each independently represent an alkenyl group having 2 to 9 carbon atoms, and Alkenyloxy's each independently represent an alkenyloxy group having 2 to 9 carbon atoms).

Preferable examples of General Formula (3) include compounds represented by the following formulae.

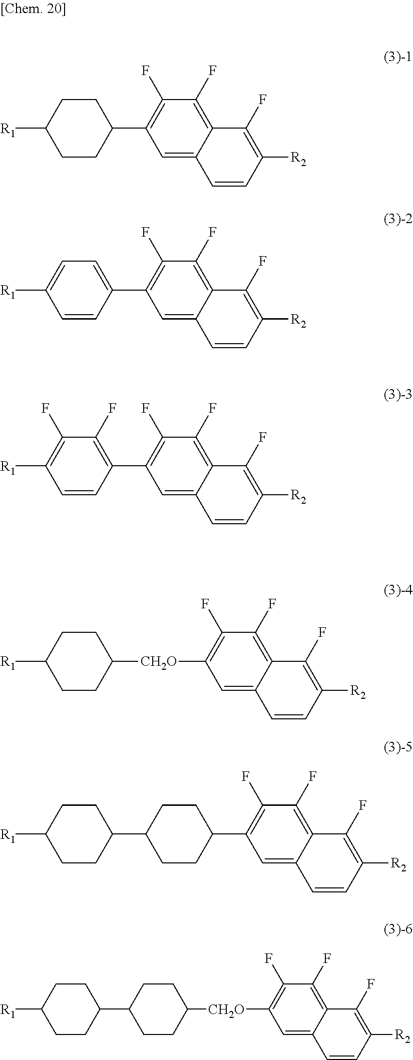

More preferable examples thereof include compounds represented by:

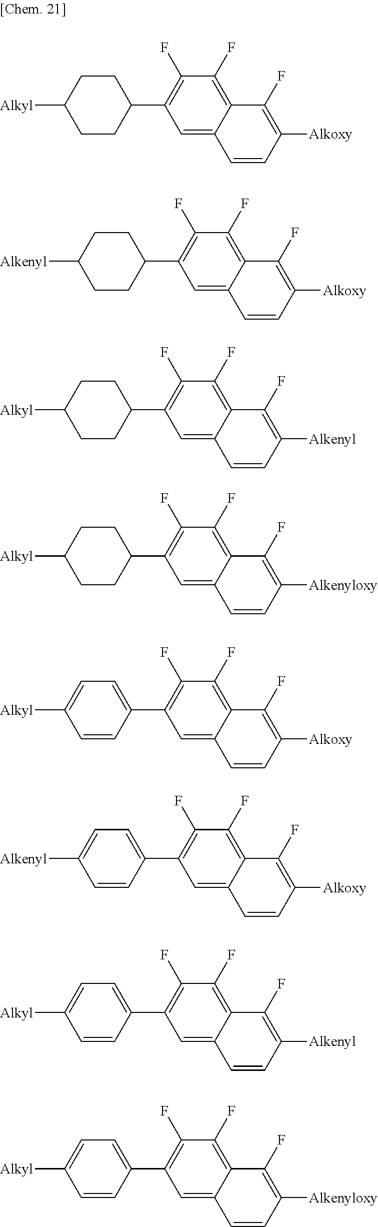

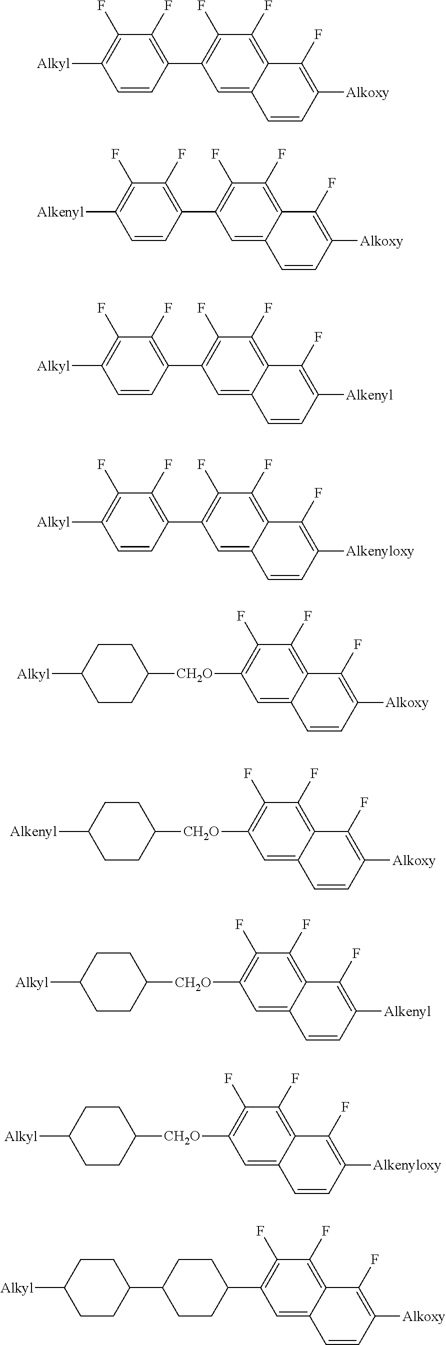

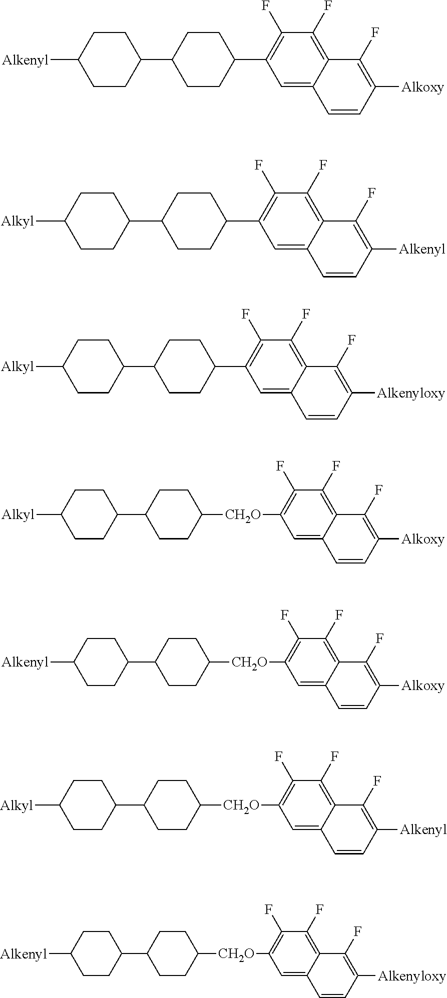

(in the formulae, Alkyl's each independently represent an alkyl group having 1 to 8 carbon atoms, Alkoxy's each independently represent an alkoxy group having 1 to 8 carbon atoms, Alkenyl's each independently represent an alkenyl group having 2 to 9 carbon atoms, and Alkenyloxy's each independently represent an alkenyloxy group having 2 to 9 carbon atoms).

Preferable examples of General Formula (4) include compounds represented by the following formulae.

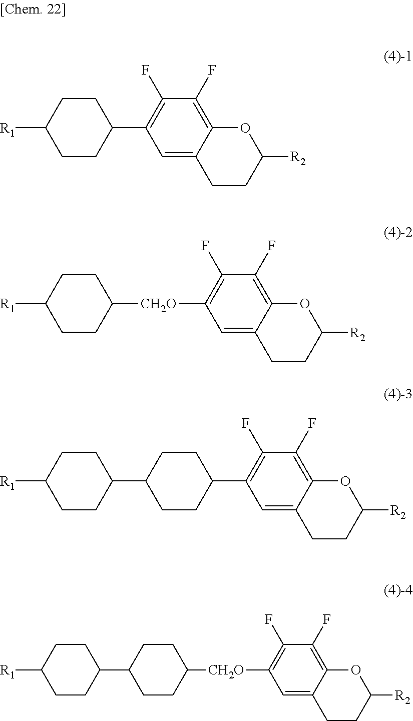

More preferable examples thereof include compounds represented by:

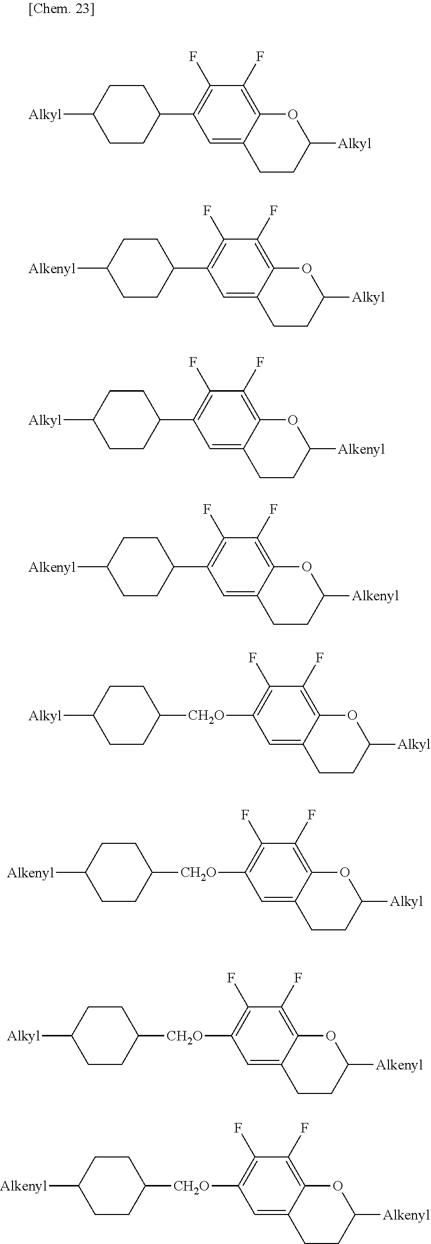

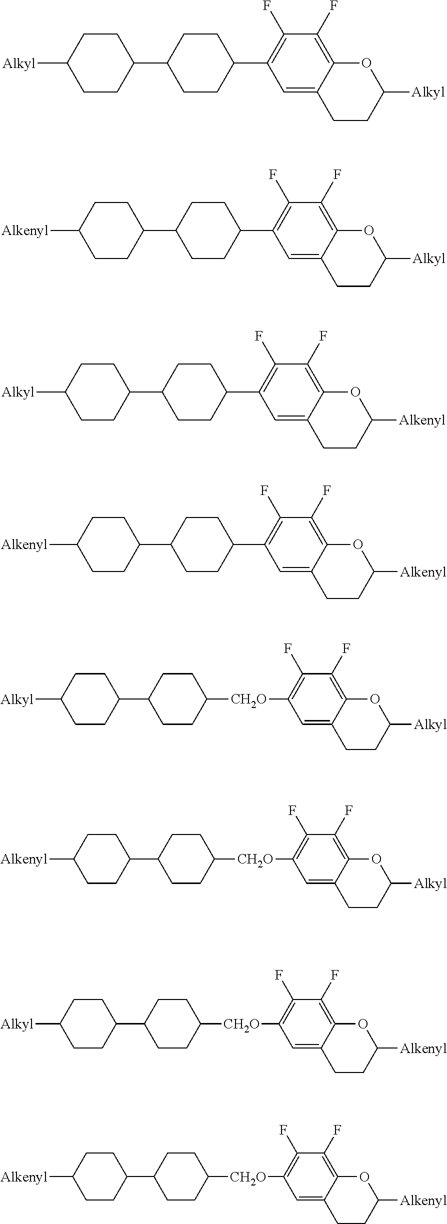

(in the formulae, Alkyl's each independently represent an alkyl group having 1 to 8 carbon atoms, and Alkenyl's each independently represent an alkenyl group having 2 to 9 carbon atoms).

In addition, one or more of compounds represented by General Formula (5):

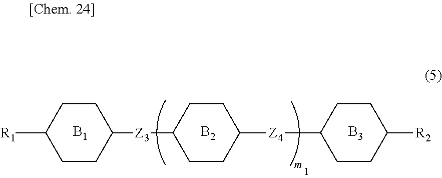

(in the formula, R₁, R₂, Z₃, Z₄, and m₁ are each independently the same as the components described in claims described above, rings B₁ to B₃ each independently represent any one of:

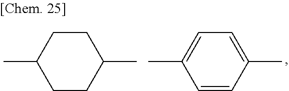

at least one CH₂ group in each of the rings B₁ to B₃ may be substituted with an O atom, and one at least one CH group in each of the rings B₁ to B₃ may be substituted with a N atom) can be included in the liquid crystal composition in the liquid crystal element.

Preferable examples of General Formula (5) include compounds represented by the following formulae.

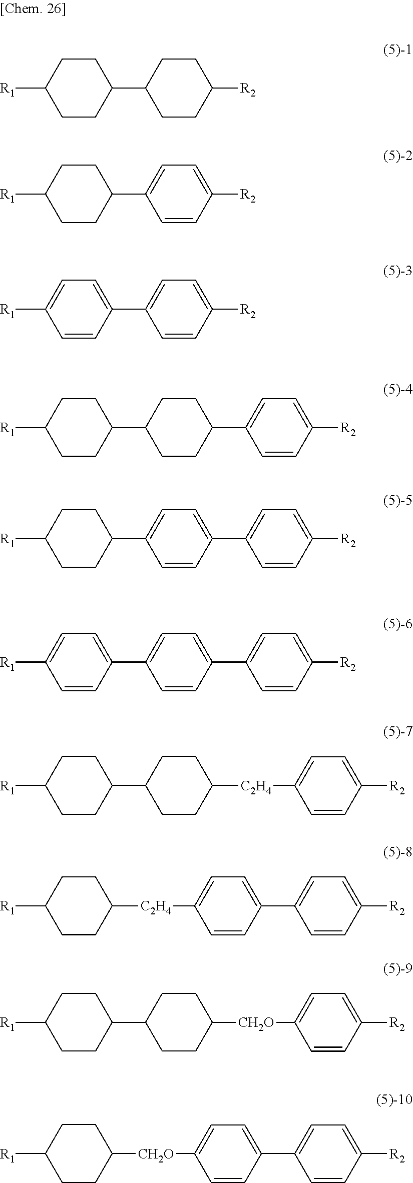

More preferable examples thereof include compounds represented by the following formulae.

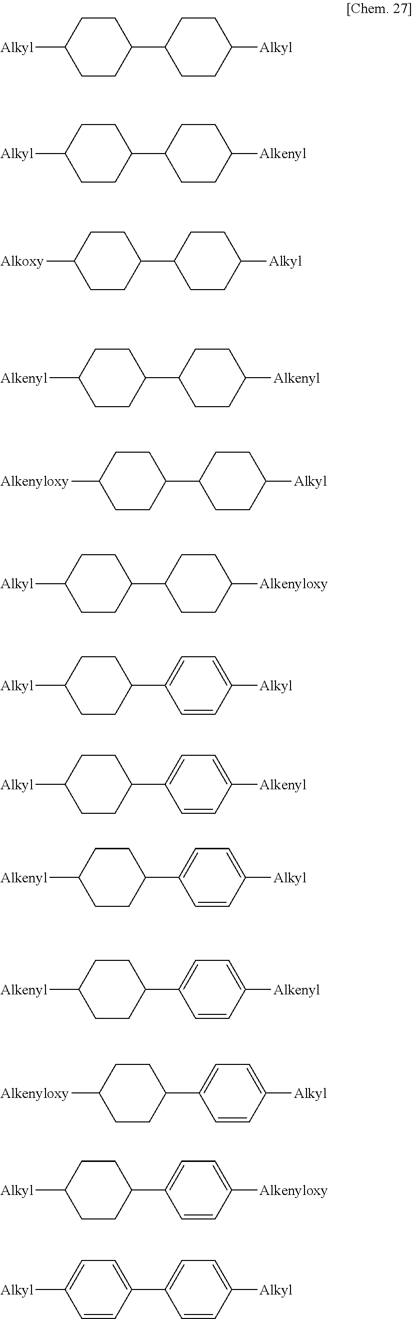

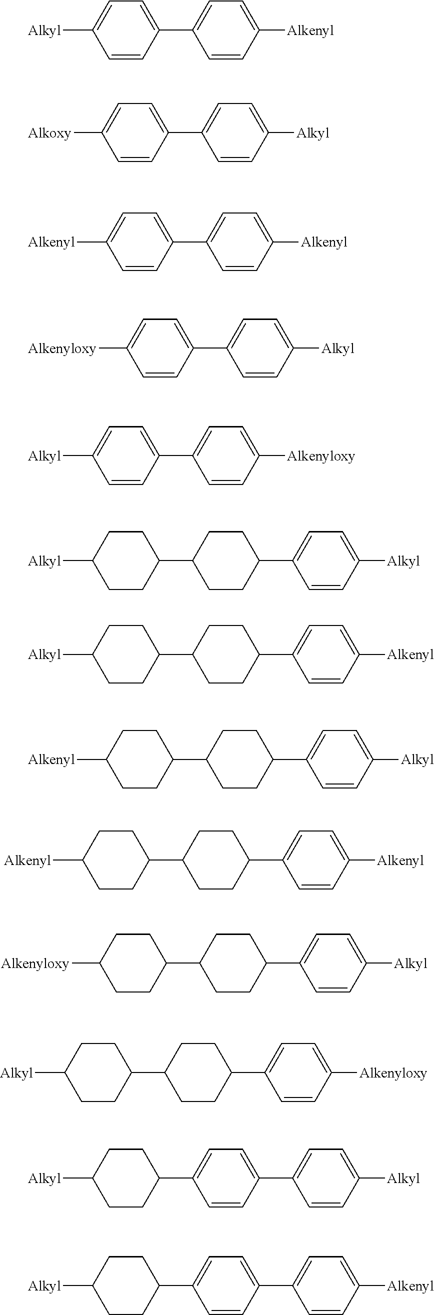

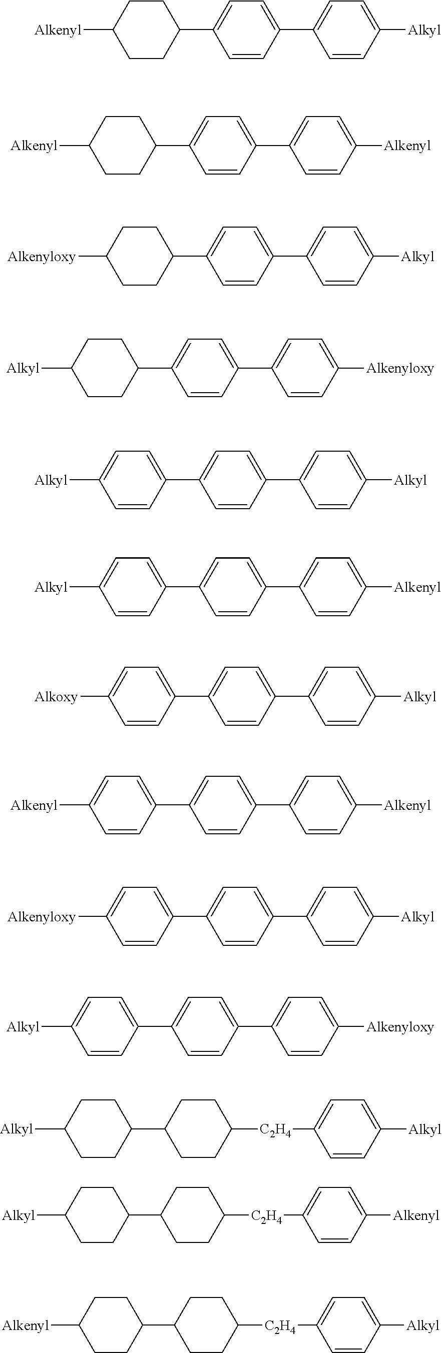

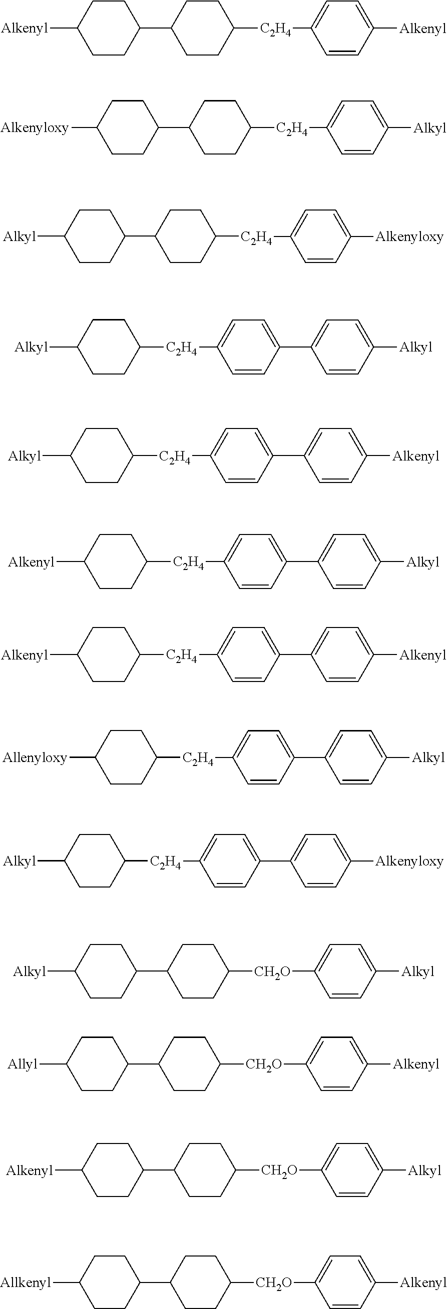

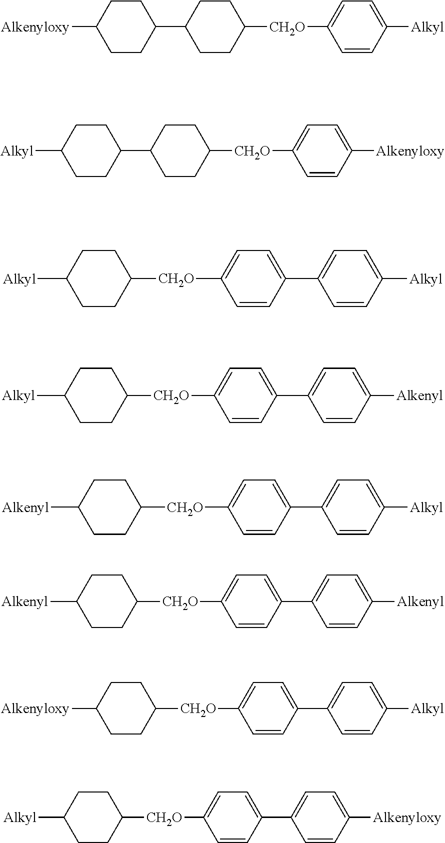

In the formulae, Alkyl's each independently represent an alkyl group having 1 to 8 carbon atoms, Alkenyl's each independently represent an alkenyl group having 2 to 9 carbon atoms, and Alkenyloxy's each independently represent an alkenyloxy group having 2 to 9 carbon atoms.

The polymerizable compound in the liquid crystal element can include at least one of a disc-like liquid crystal compound having a structure containing a benzene derivative, a triphenylene derivative, a truxene derivative, a phthalocyanine derivative, or a cyclohexane derivative as a core of the center of a molecule, and a linear alkyl group, a linear alkoxy group, or a substituted benzoyloxy group as substituents being present radially on side chains thereof.

Specifically, the polymerizable compound can be a polymerizable compound represented by General Formula (6).

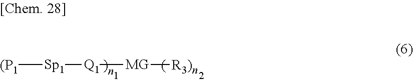

In the formula, P₁ represents a polymerizable functional group, Sp₁ represents a spacer group having 0 to 20 carbon atoms, Q₁ represents a single bond, —O—, —NH—, —NHCOO—, —OCONH—, —CH═CH—, —CO—, —COO—, —OCO—, —OCOO—, —OOCO—, —CH═CH—, —CH═CH—COO—, —OCO—CH═CH—, or —C≡C—, n₁ and n₂ represent 1, 2, or 3, MG represents a mesogen group or a mesogen support group, and R₃ represents a halogen atom, a cyano group, or an alkyl group having 1 to 25 carbon atoms, at least one CH₂ group in the alkyl group may be substituted with —O—, —S—, —NH—, —N(CH₃)—, —CO—, —COO—, —OCO—, —OCOO—, —SCO—, —COS—, or —C≡C—, provided that 0 atoms are not directly adjacent to each other, or R₃ represents P₂—Sp₂-Q₂, and P₂, Sp₂, and Q₂ are each independently the same as P₁, Sp₁, and Q₁.

The polymerizable compounds represented by General Formula (6) may be polymerizable compounds represented by (6)-1 or (6)-2.

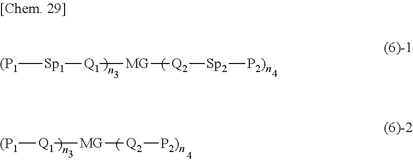

MG of General Formula (6) is one represented by the following formula:

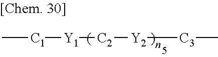

(in the formula, C₁ to C₃ each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2) octylene group, a decahydronaphthalene-2,6-diyl group, a pyridine-2,5-diyl group, a pyrimidine-2,5-diyl group, a pyrazine-2,5-diyl group, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene 2,7-diyl group, or a fluorene 2,7-diyl group, the 1,4-phenylene group, the 1,2,3,4-tetrahydronaphthalene-2,6-diyl group, the 2,6-naphthylene group, the phenanthrene-2,7-diyl group, the 9,10-dihydrophenanthrene-2,7-diyl group, the 1,2,3,4,4a,9,10a-octahydrophenanthrene 2,7-diyl group, and the fluorene 2,7-diyl group may include one or more of F, Cl, CF₃, OCF₃, a cyano group, an alkyl group having 1 to 8 carbon atoms, an alkoxy group, an alkanoyl group, an alkanoyloxy group, an alkenyl group having 2 to 8 carbon atoms, an alkenyloxy group, an alkenoyl group, or an alkenoyloxy group as a substituent, Y₁ and Y₂ each independently represent a —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, or a single bond, and n₅ represents 0, 1, or 2), or a disc-like liquid crystal compound represented by General Formula (6)-13:

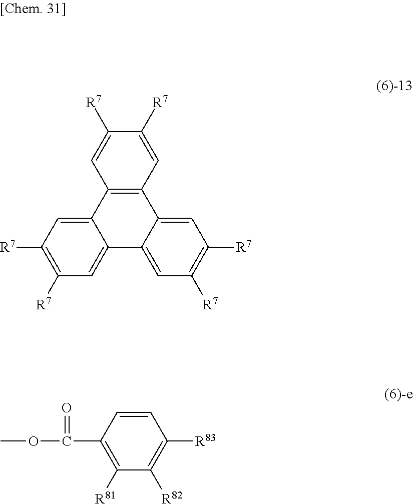

(in the formula, R⁷'s each independently represent P¹-Sp¹-Q¹ or a substituent of Formula (6-e), R⁸¹ and R⁸² each independently represent a hydrogen atom, a halogen atom, or a methyl group, R⁸³ represents an alkoxy group having 1 to 20 carbon atoms, and at least one hydrogen atom in the alkoxy group includes a substituent represented by Formulae (6-a) to (6-d) described in claim 18).

In addition, Sp₁ and Sp₂ of General Formula (6) each independently represent an alkylene group, the alkylene group may be substituted with one or more of halogen atoms or CN, and one or more of CH₂ groups present in this group may be substituted with —O—, —S—, —NH—, —N(CH₃)—, —CO—, —COO—, —OCO—, —OCOO—, —SCO—, —COS—, or —C≡C—, provided that O atoms are not directly adjacent to each other.

In addition, P₁ and P₂ of General Formula (6) may each independently represent any one of:

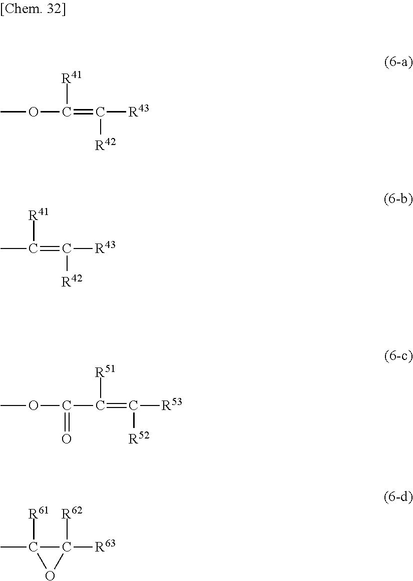

(in the formulae, R⁴¹ to R⁴³, R⁵¹ to R⁵³, and R⁶¹ to R⁶³ each independently represent a hydrogen atom, a halogen atom, or an alkyl group having 1 to 5 carbon atoms).

Preferable examples of General Formula (6) include:

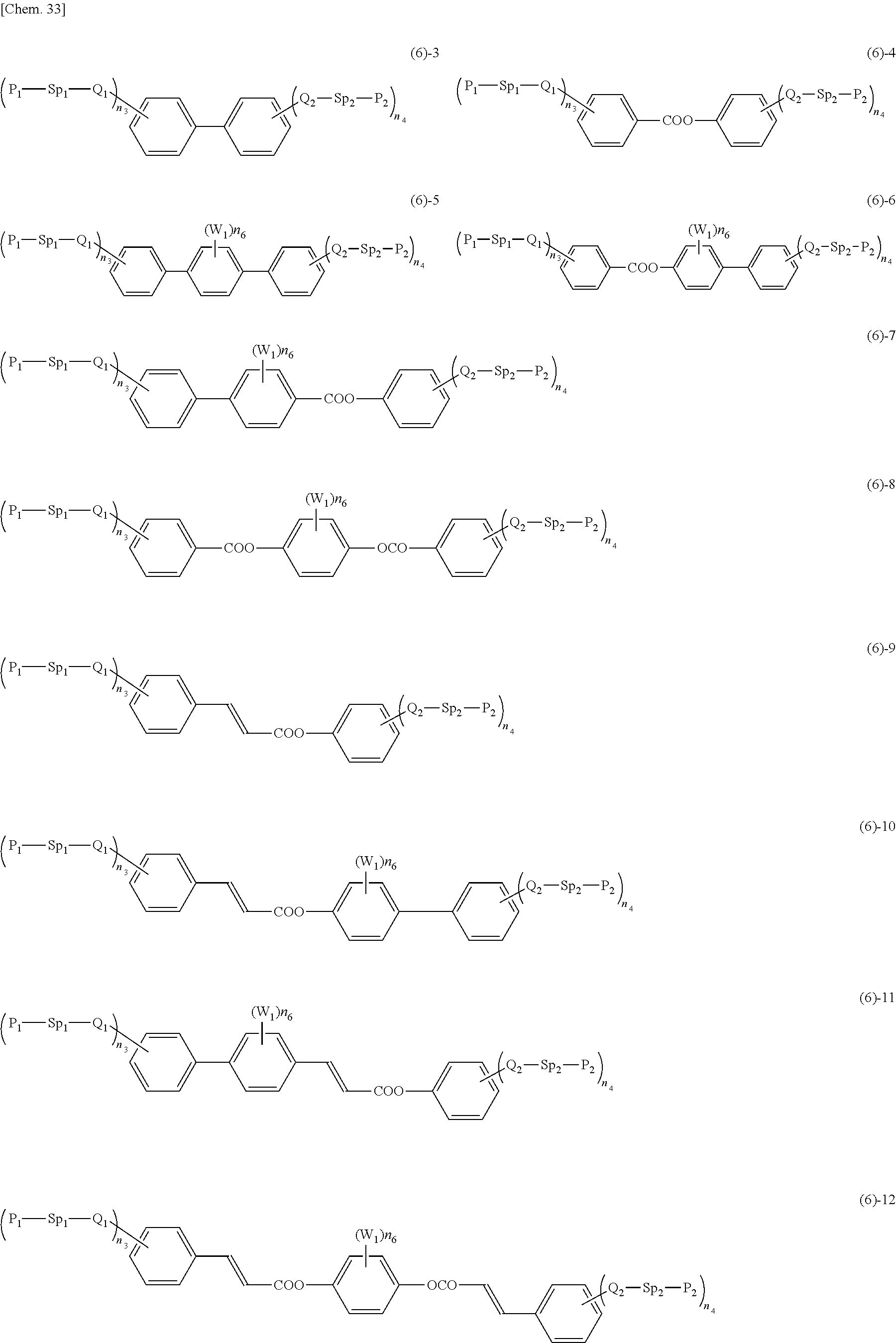

(in the formulae, W₁'s each independently represent F, CF₃, OCF₃, CH₃, OCH₃, an alkyl group having 2 to 5 carbon atoms, an alkoxy group, an alkenyl group, COOW₂, OCOW₂, or OCOOW₂, here, W₂ represents a linear or branched alkyl group having 1 to 10 carbon atoms or an alkenyl group having 2 to 5 carbon atoms, and n₆ represents 0, 1, 2, 3, or 4), or a polymerizable compound in which at least one of Sp₁, Sp₂, Q₁, and Q₂ of General Formula (6) is a single bond or n₃+n₄ is 3 to 6.

More preferable examples thereof include a polymerizable compound in which P₁ and P₂ of General Formula (6) is Formula (6-b) described in claim 17, a polymerizable compound in which W₁ of General Formulae (6)-5 to (6)-8 or (6)-10 to (6)-12 is F, CF₃, OCF₃, CH₃, or OCH₃, and n⁶ is equal to or greater than 1, or a polymerizable compound selected from the group consisting of the compounds represented by General Formulae (6)-5 to (6)-12.

The liquid crystal composition in the liquid crystal element may include or substantially may not include an initiator, and the liquid crystal composition preferably does not substantially include an initiator.

In addition, the liquid crystal composition in the liquid crystal element preferably includes 0.1% to 10.0% by weight of the polymerizable compound and more preferably includes 0.1% to 2.0% by weight of the polymerizable compound.

In this specification, the inventors used a new analysis method which is developed for performing an accurate measurement of the amount of the residual monomer. A base on a side of a cell which is an analysis target is peeled off, and a liquid crystal attached to the inner surface of the base is collected by blowing inert gas, and is set as a sample. A solvent is added to the sample, the resultant material is filtered through a filter, the amount of residual monomer is measured by a high performance liquid chromatography (HPLC) device, and a percentage of the residual monomer is calculated. Accordingly, the detection of the percentage of the residual monomer which is equal to or smaller than approximately 0.3% was not possible in the related art, but it is currently possible to perform a detection of the percentage of the residual monomer in such a range with excellent accuracy.

A compound represented by General Formula (7) can be further included as other compounds.

One or more of compounds represented by:

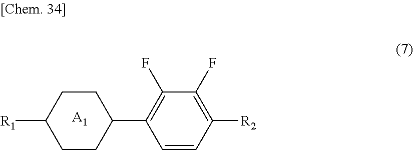

(in the formula, R₁, R₂, and the ring A₁ are each independently the same as the components described in claim 1) can be included. An upper limit value of the preferable content of these compounds in the liquid crystal composition is 5%, 4%, 3%, 2%, or 1%, and it is preferable that these compounds are not substantially included. Not substantially including a component means intentionally not including a component.

### EXAMPLES

Hereinafter, the present invention will be further described with reference to examples, but the present invention is not limited thereto. In addition, “%” means “% by mass”.

T_{N-I}: A nematic phase-isotropic liquid phase transition temperature (° C.) is set as a liquid crystal phase upper limit temperature.

T_{-N}: A solid phase or a smectic phase-nematic phase transition temperature (° C.) is set as a liquid crystal phase lower limit temperature.

Δ∈: dielectric anisotropy at 25° C.

Δn: refractive index anisotropy at 25° C.

η: viscosity at 20° C.

V0: threshold value voltage at 20° C.

γ1: rotational viscosity coefficient at 20° C.

These values of physical properties are values regarding a liquid crystal mixture before adding a monomer.

VHR (after polymerization process): voltage holding ratio (%) at 25° C. after a polymerization process

VHR (after polymerization process, heated at 150° C. for 1 hour): voltage holding ratio (%) at 25° C. after a polymerization process, remaining in an oven at 150° C. for 1 hour, and natural cooling

VHR (after polymerization process, suntest, 30 min): voltage holding ratio (%) at 25° C. after a polymerization process, and remaining in a suntest for 30 minutes

ID (after polymerization process): ion density at 25° C. after a polymerization process

ID (after polymerization process, heated at 150° C. for 1 hour): ion density at 25° C. after a polymerization process, remaining in an oven at 150° C. for 1 hour, and natural cooling

ID (after polymerization process, suntest, 30 min): ion density at 25° C. after a polymerization process, and remaining in a suntest for 30 minutes

(In the measurement conditions of the voltage holding ratio, an applied voltage was 5 V, a frame time was 16.5 msec, and a pulse width was 62 μsec. In the measurement conditions of the ion density, an applied voltage was 20 V, a triangular wave was 0.05 Hz, R Sense was 5×10⁶Ω, and a gain was 100. For the suntest, SUNTEST CPS+, manufactured by Toyo Seiki Seisaku-sho, Ltd., was used. For measuring all of the values, a VA mode cell (cell thickness of 3.5 μm, alignment film RN-1517), which the liquid crystal composition was injected thereinto followed by being irradiated with ultraviolet light for 600 seconds (3.0 J/cm²) to perform the polymerization process, was used.

The following abbreviations are used for describing the compounds.

n—CₙH₂ₙ₊₁—

-2— —CH₂CH₂—

-1O— —CH₂O—

—O1— —OCH₂—

-On— —OCₙH₂ₙ₊₁

ndm—CₙH₂ₙ₊₁—CH═CH—(CH₂)ₘ₋₁—

As a base material 20-113, a mixture of the following compounds was used.

TABLE 1

| | |
|---|---|
| 3-Cy-Ph—O2 | 20% |
| 3-Cy-Ph—O4 | 20% |
| 0d1-Cy-Cy-Ph-1 | 30% |
| 0d3-Cy-Cy-Ph-1 | 30% |
| T_{N-I} | 103.1 |
| Δn | 0.0984 |
| Δϵ | 0.04 |

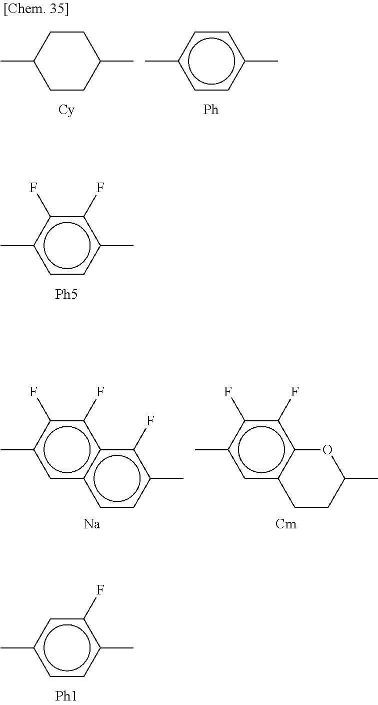

The values of the physical properties of the liquid crystal compositions and elements of Example 1 which is the liquid crystal element of the present invention and Comparative Example 1 are shown in Table 2. 2% of the polymerizable compound (Ph-3H) was added with respect to 98% of the liquid crystal composition. 2% of the polymerization initiator (Irg651) was added with respect to the polymerizable compound.

TABLE 2

| | | COMPARATIVE |
|---|---|---|
| | EXAMPLE 1 | EXAMPLE 1 |
| 3-Cy-Ph5—O4 | | 8% |
| 5-Cy-Ph5—O2 | | 16% |
| 5-Cy-Ph5—O4 | | 8% |
| 3-Cy-Cy-Ph5—O2 | 14% | 12% |
| 4-Cy-Cy-Ph5—O2 | 14% | 12% |
| 5-Cy-Cy-Ph5—O2 | 14% | 12% |
| 3-Cy-Cy-Ph5-1 | | 3% |
| 0d1-Cy-Cy-3 | 18% | |
| 0d1-Cy-Cy-5 | 20% | 10% |
| 1d1-Cy-Cy-3 | | 10% |
| 3-Cy-Cy-5 | | 5% |
| 3-Cy-Ph-5 | 6% | |
| 4-Cy-1O—Na—O3 | 7% | |
| 5-Cy-1O—Na—O3 | 7% | |
| 0d1-Cy-Cy-Ph-1 | | 4% |
| T_{N-I} | 83.4 | 83.7 |
| Δn | 0.0816 | 0.0824 |
| Δϵ | −4.1 | −4.2 |
| V0 | 1.98 | 1.99 |
| γ1 | 108 | 178 |
| Percentage of residual monomer | 2.8% | 11.9% |
| VHR (after polymerization process) | 94.6% | 92.8% |
| ID (after polymerization process) | 98 | 178 |

In Example 1, the values of the physical properties required for a liquid crystal television were satisfied and values of VHR (after polymerization process) and ID (after polymerization process) were excellent. On the other hand, regarding the liquid crystal composition of Comparative Example 1, γ1 was large and therefore, the response time appears to be long. The percentage of the residual monomer after polymerization process was large, and the values of VHR (after polymerization process) and ID (after polymerization process) were not good, as compared with those in Example 1. From the above results, it is found that, in Example 1 which is the liquid crystal element of the present invention, the properties required for a liquid crystal television are satisfied, the percentage of the residual monomer is sufficiently decreased, reliability is excellent, and thus, the liquid crystal element is significantly useful as a long-life active matrix-type liquid crystal display element.

In addition, the values of the physical properties of the liquid crystal compositions and elements of Example 2 and Comparative Example 2 are shown in Table 3. 2% of the polymerizable compound (Ph-3H) was added with respect to 98% of the liquid crystal composition. 2% of the polymerization initiator (Irg651) was added with respect to the polymerizable compound.

TABLE 3

| | | COMPARATIVE |
|---|---|---|
| | EXAMPLE 2 | EXAMPLE 2 |
| 3-Cy-Ph5—O4 | | 5% |
| 5-Cy-Ph5—O2 | | 12% |
| 5-Cy-Ph5—O4 | | 12% |
| 3-Cy-Cy-Ph5—O2 | 14% | 7% |
| 4-Cy-Cy-Ph5—O2 | 7% | |
| 5-Cy-Cy-Ph5—O2 | 14% | 7% |
| 2-Cy-Ph—Ph5—O2 | 12% | 12% |
| 3-Cy-Ph—Ph5—O2 | 12% | 12% |
| 0d1-Cy-Cy-3 | 8% | |
| 0d1-Cy-Cy-5 | 20% | 8% |
| 5-Cy-1O—Na—O3 | | 5% |
| 0d1-Cy-Cy-Ph-1 | | 12% |
| 3-Ph—Ph1—Ph-0d3 | 5% | |
| 3-Ph—Ph—Ph—O1 | 8% | 8% |
| T_{N-I} | 89.4 | 89.8 |
| Δn | 0.1211 | 0.1207 |
| Δϵ | −4.3 | −4.6 |
| V0 | 2.02 | 2.01 |
| γ1 | 163 | 216 |
| Percentage of residual monomer | 3.1% | 12.1% |
| VHR (after polymerization process) | 94.9% | 93.1% |
| ID (after polymerization process) | 102 | 183 |

In Example 2, the values of the physical properties required for a liquid crystal television were satisfied and values of VHR (after polymerization process) and ID (after polymerization process) were excellent. On the other hand, regarding the liquid crystal composition of Comparative Example 1, γ1 was large and therefore, the response time appears to be long. The percentage of the residual monomer after polymerization process was large, and the values of VHR (after polymerization process) and ID (after polymerization process) were not good, as compared with those in Example 2. From the above results, it is found that, in Example 2 which is the liquid crystal element of the present invention, the properties required for a liquid crystal television are satisfied, the percentage of the residual monomer is sufficiently decreased, reliability is excellent, and thus, the liquid crystal element is significantly useful as a long-life active matrix-type liquid crystal display element.

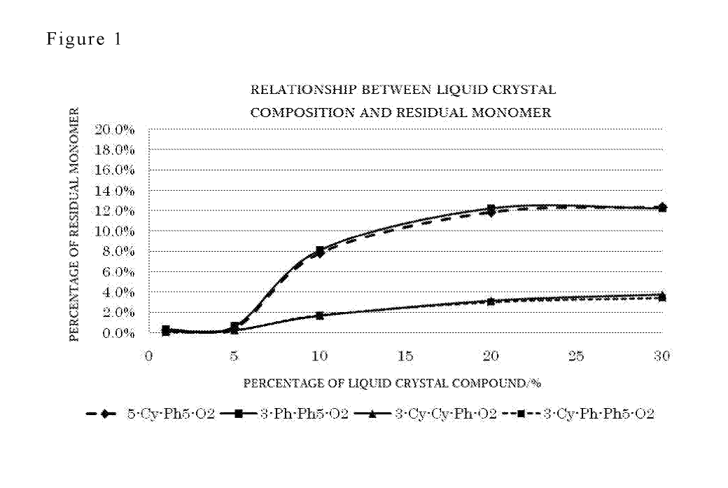

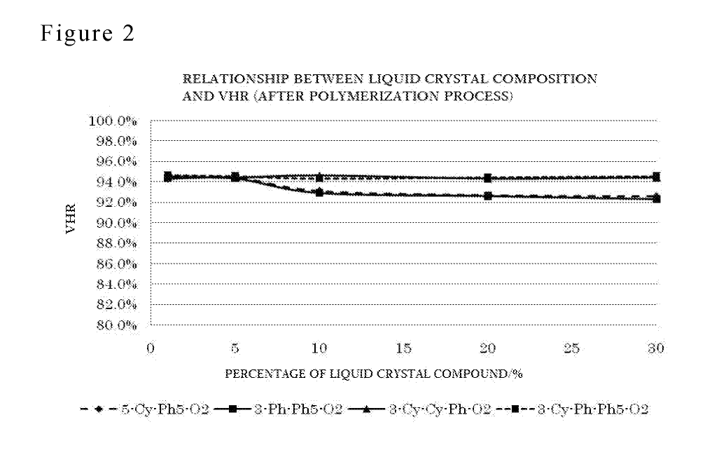

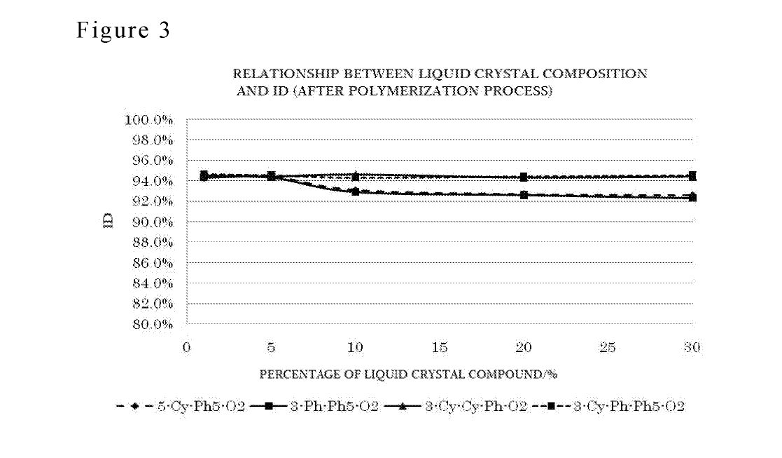

Further, in order to confirm a relationship between the liquid crystal composition and the percentage of the residual monomer, the VHR, and the ID, results obtained by performing experiments of changing the additive amounts of the liquid crystal base 20-113 and the liquid crystal compounds are shown in Table 3, Table 4, FIG. 1, FIG. 2, and FIG. 3.

TABLE 4
Relationship between liquid crystal composition and residual monomer, VHR, and ID

| | Composition percentage/% | | | | | | | | | |
|---|---|---|---|---|---|---|---|---|---|---|
| Base | 94 | 90 | 85 | 75 | 65 | 94 | 90 | 85 | 75 | 65 |
| 5-Cy-Ph5—O2 | 1 | 5 | 10 | 20 | 30 | | | | | |
| 3-Ph—Ph5—O2 | | | | | | 1 | 5 | 10 | 20 | 30 |
| 3-Cy-Cy-Ph—O2 | | | | | | | | | | |
| 3-Cy-Ph—Ph5—O2 | | | | | | | | | | |
| LAI-003 (monomer) | 5 | 5 | 5 | 5 | 5 | 5 | 5 | 5 | 5 | 5 |
| Percentage of residual monomer | 0.2% | 0.4% | 7.8% | 11.8% | 12.3% | 0.3% | 0.6% | 8.1% | 12.2% | 12.2% |
| VHR (after polymerization process) | 94.3% | 94.4% | 93.1% | 92.7% | 92.6% | 94.3% | 94.3% | 92.9% | 92.6% | 92.3% |
| VHR (after polymerization process, | 94.5% | 94.5% | 93.2% | 92.9% | 92.7% | 94.4% | 94.3% | 93.0% | 92.7% | 92.6% |
| heated at 150° C. for 1 hr) | | | | | | | | | | |
| VHR (after polymerization process, | 94.6% | 94.4% | 93.5% | 93.2% | 93.1% | 94.6% | 94.6% | 93.3% | 93.0% | 93.2% |
| suntest, 30 min) | | | | | | | | | | |
| ID (after polymerization process) | 132 | 138 | 167 | 178 | 185 | 145 | 142 | 172 | 183 | 205 |
| ID (after polymerization process, | 128 | 133 | 174 | 182 | 197 | 137 | 139 | 181 | 194 | 198 |
| heated at 150° C. for 1 hr) | | | | | | | | | | |
| ID (after polymerization process, | 141 | 135 | 168 | 176 | 178 | 143 | 145 | 182 | 189 | 195 |
| suntest, 30 min) | | | | | | | | | | |

The base is 20-113, the Irg651 as the polymerization initiator is added to monomer in an amount of 2% with respect to the monomer, UV: 600 sec (3.0 J/cm²)

TABLE 5
Relationship between liquid crystal composition and residual monomer, VHR, and ID

| | Composition percentage/% | | | | | | | | | |
|---|---|---|---|---|---|---|---|---|---|---|
| Base | 94 | 90 | 85 | 75 | 65 | 94 | 90 | 85 | 75 | 65 |
| 5-Cy-Ph5—O2 | | | | | | | | | | |
| 3-Ph-Ph5—O2 | | | | | | | | | | |
| 3-Cy-Cy-Ph—O2 | 1 | 5 | 10 | 20 | 30 | | | | | |
| 3-Cy-Ph—Ph5—O2 | | | | | | 1 | 5 | 10 | 20 | 30 |
| LAI-003 (monomer) | 5 | 5 | 5 | 5 | 5 | 5 | 5 | 5 | 5 | 5 |
| Percentage of residual monomer | 0.1% | 0.2% | 1.6% | 3.1% | 3.7% | 0.0% | 0.2% | 1.7% | 3.0% | 3.4% |
| VHR (after polymerization process) | 94.5% | 94.4% | 94.6% | 94.3% | 94.4% | 94.6% | 94.5% | 94.3% | 94.4% | 94.5% |
| VHR (after polymerization process, | 94.6% | 94.6% | 94.5% | 94.7% | 94.5% | 94.7% | 94.6% | 94.6% | 94.7% | 94.6% |
| heated at 150° C. for 1 hr) | | | | | | | | | | |
| VHR (after polymerization process, | 94.6% | 94.7% | 94.3% | 94.5% | 94.6% | 94.6% | 94.6% | 94.4% | 94.5% | 94.5% |
| suntest, 30 min) | | | | | | | | | | |
| ID (after polymerization process) | 107 | 111 | 108 | 102 | 118 | 122 | 120 | 126 | 123 | 125 |
| ID (after polymerization process, | 110 | 115 | 109 | 118 | 115 | 126 | 124 | 123 | 127 | 127 |
| heated at 150° C. for 1 hr) | | | | | | | | | | |
| ID (after polymerization process, | 109 | 106 | 112 | 111 | 113 | 127 | 125 | 130 | 132 | 128 |
| suntest, 30 min) | | | | | | | | | | |

The base is 20-113, the Irg651 as the polymerization initiator is added to the monomer in an amount of 2% with respect to the monomer, UV: 600 sec (3.0 J/cm²)

As shown in Table 2, when the additive amount of 5-Cy-Ph5-O2 or 3-Ph-Ph5-O2 which is the liquid crystal compound corresponding to Formula (1) is equal to or smaller than 5%, the percentage of the residual monomer shows a sufficiently small value, but when the additive amount thereof is equal to or greater than 10%, the percentage of the residual monomer is increased. In addition, the VHR (after polymerization process) which is related to the display properties or reliability is decreased, and the ID (after polymerization process) is increased. However, as shown in Table 3, even when the additive amount of 3-Cy-Cy-Ph-O2 or 3-Cy-Ph-Ph5-O2 which is the liquid crystal compound corresponding to Formula (2) is increased, the percentage of the residual monomer is sufficiently small, the VHR (after polymerization process) which is related to the display properties or reliability or the ID (after polymerization process) is also excellent.

1. A liquid crystal element,
in which a liquid crystal composition is disposed between a pair of substrates on which a transparent electrode and an alignment film are formed,
the liquid crystal composition comprises:
a liquid crystal compound which has three or four ring structures and a negative dielectric anisotropy (Δ∈) whose absolute value is 1 or more,
a liquid crystal compound which has two, three, or four ring structures and a dielectric anisotropy (Δ∈) whose absolute value is 1 or more, and
a polymer of a polymerizable compound,
wherein the total content of the liquid crystal compound which has three or four ring structures and a negative dielectric anisotropy (Δ∈) whose absolute value ∈ is 1 or more, the liquid crystal compound which has two, three, or four ring structures and a dielectric anisotropy (Δ∈) whose absolute value is 1 or less, and the polymerizable compound before polymerization in the liquid crystal composition used in the liquid crystal element is equal to or greater than 95% of the total content of the liquid crystal composition and the polymerizable compound before polymerization, and
the liquid crystal compound which has three or four ring structures and a negative dielectric anisotropy (Δ∈) whose absolute value is 1 or more includes one or more of compounds represented by General Formula (1): 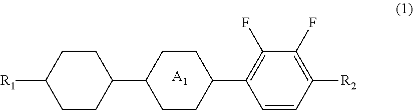
wherein R₁ and R₂ each independently represent an alkyl group having 1 to 15 carbon atoms, at least one CH₂ group in the alkyl group may be substituted with —O—, —CH═CH—, —CO—, —OCO—, —COO—, —≡C—, —CF₂O—, and —OCF₂— provided that oxygen atoms are not directly adjacent to each other, at least one hydrogen atom in the alkyl group may be arbitrarily substituted with a halogen atom, a ring A₁ represents any one of: 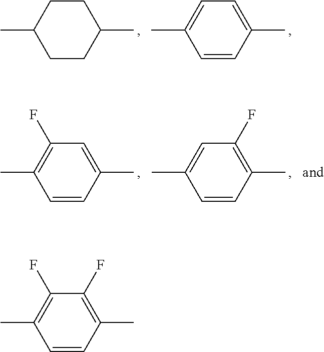
at least one CH₂ group in the ring A₁ may be substituted with an O atom, at least one CH group in the ring A₁ may be substituted with a N atom, and at least one H atom in the ring A₁ may be substituted with Cl, CF₃, or OCF₃.

2. The liquid crystal element according to claim 1,
wherein the liquid crystal composition comprises one or more of compounds represented by General Formulae (2) to (4): 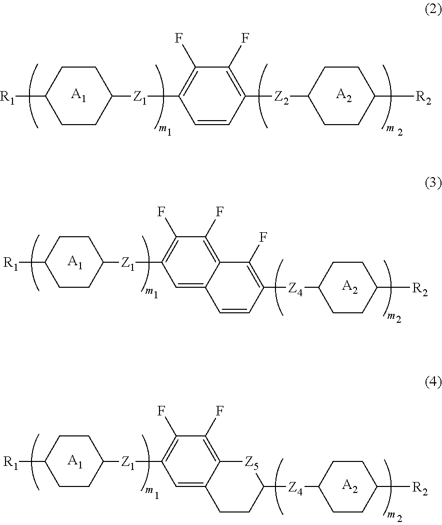
wherein R₁, R₂, and the ring A₁ each are the same as defined in claim 1, the ring A₂ each is the same as the ring A₁ defined in claim 1, Z₁ to Z₄ each independently represent a single bond, —CH═CH—, —≡C—, —CH₂CH₂—, —(CH₂)₄—, —COO—, —OCH₂—, —CH₂O—, —OCF₂—, or —CF₂O—, at least one of Z₁ and Z₂ is not a single bond, Z₅ represents a CH₂ group or an O atom, m₁ and m₂ each independently represent 0 to 3, and the sum of m₁+m₂ in each formula is 1, 2, or 3.

3. The liquid crystal element according to claim 1,
wherein the liquid crystal composition comprises one or more of compounds represented by General Formula (5): 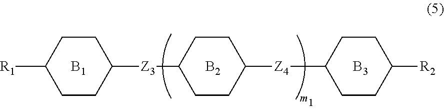
wherein R₁, R₂, Z₃, Z₄, and m₁ each are the same as defined in the preceding claim, rings B₁ to B₃ each independently represent any one of: 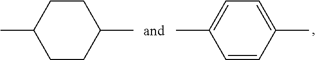
at least one CH₂ group in the rings B₁ to B₃ may be substituted with an O atom, and at least one CH group in each of the rings B₁ to B₃ may be substituted with an N atom.

4. The liquid crystal element according to claim 1,
wherein the liquid crystal composition comprises one or more of compounds represented by Formulae (1)-1 to (1)-3 as the compound represented by General Formula (1): 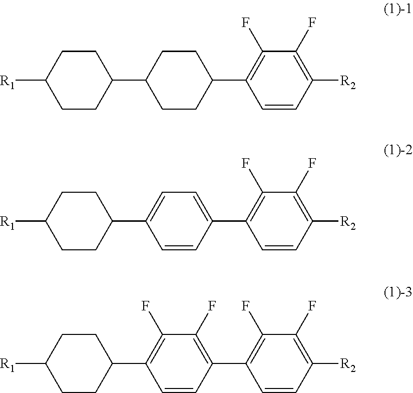
wherein R₁ and R₂ each are the same as defined in claim 1.

5. The liquid crystal element according to claim 2,
wherein the liquid crystal composition comprises one or more of compounds represented by Formulae (2)-1 to (2)-10 as the compound represented by General Formula (2): 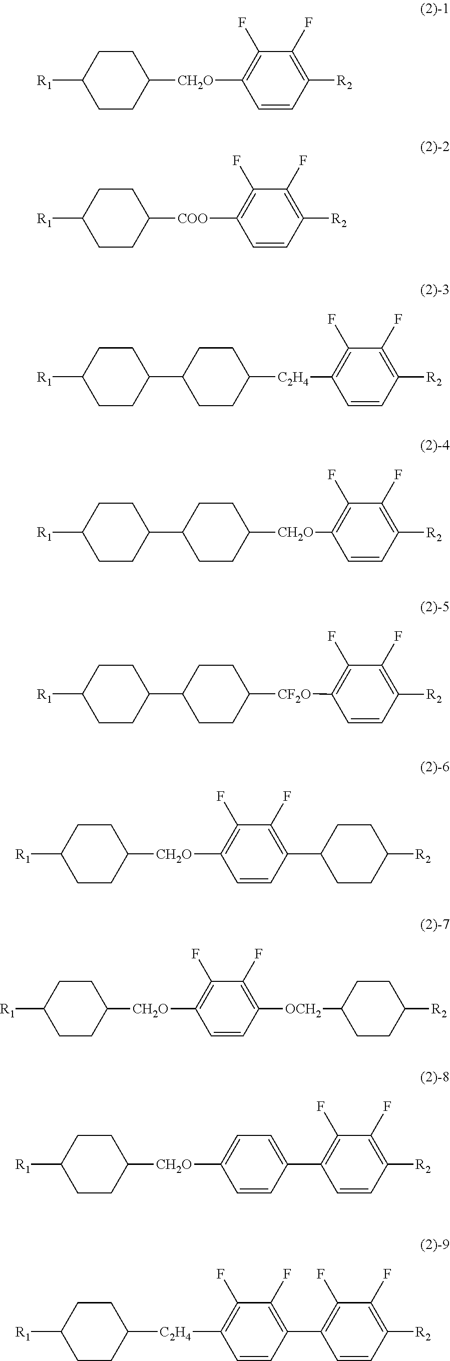 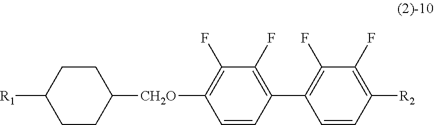
wherein R₁ and R₂ each are the same as defined in the preceding claim.

6. The liquid crystal element according to claim 2,
wherein the liquid crystal composition comprises one or more of compounds represented by Formulae (3)-1 to (3)-5 and (4)-1 to (4)-4 as the compound represented by General Formula (3) or (4): 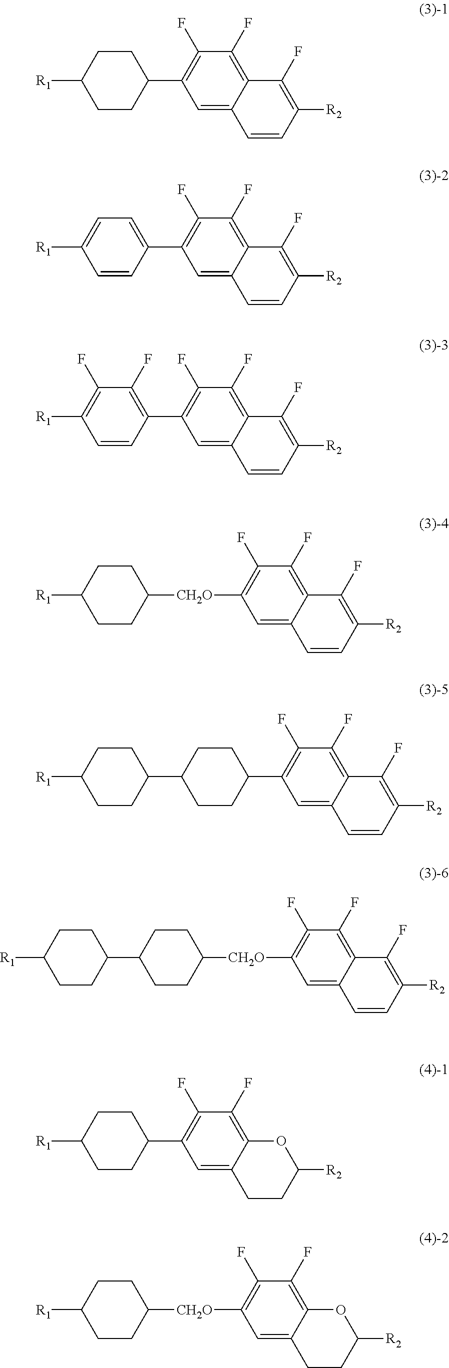 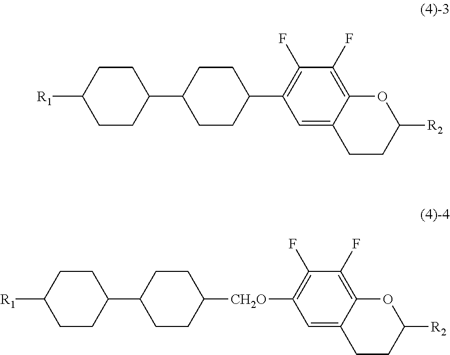
wherein R₁ and R₂ each are the same as defined in the preceding claim.

7. The liquid crystal element according to claim 3,
wherein the liquid crystal composition comprises one or more of compounds represented by General Formula (5): 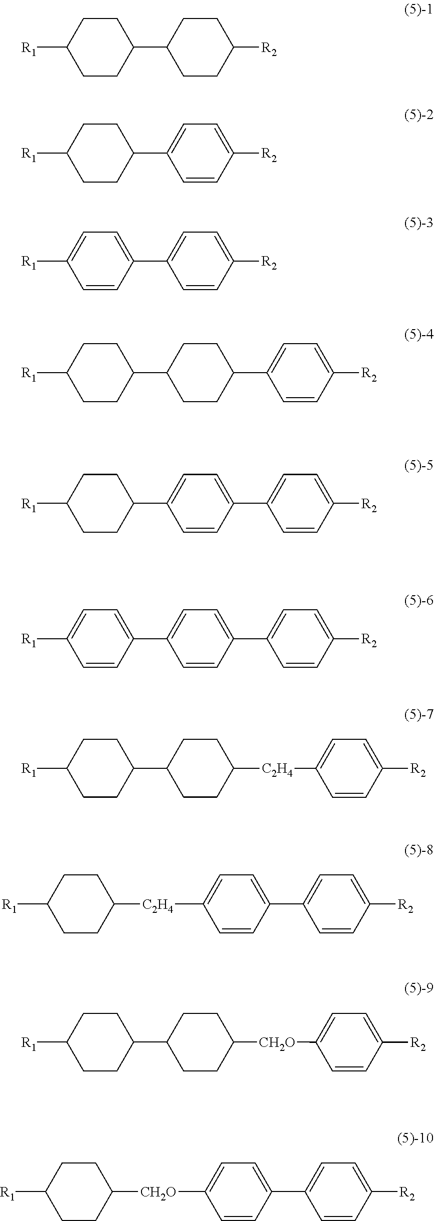
wherein R₁ and R₂ each are the same as defined in the preceding claim.

8. The liquid crystal element according to claim 1,
wherein the liquid crystal composition comprises one or more of compounds represented by General Formula (1) in which R₁ is an alkenyl group and/or R₂ is an alkoxy group or an alkenyloxy group.

9. The liquid crystal element according to claim 2,
wherein the liquid crystal composition comprises one or more of compounds of General Formulae (2) to (4) in which at least one of R₁ and R₂ is an alkenyl group.

10. The liquid crystal element according to claim 2,
wherein the liquid crystal composition comprises one or more of compounds of General Formula (2) in which at least one of Z₁ and Z₂ is —OCH₂— or —CH₂O—.

11. The liquid crystal element according to claim 3,
wherein the liquid crystal composition comprises one or more of compounds of General Formula (5) in which R₁ and/or R₂ is an alkenyl group or an alkenyloxy group.

12. The liquid crystal element according to claim 3,
wherein the liquid crystal composition comprises two or more of compounds of General Formula (5) in which one of Z₃ and Z₄ is —CH═CH—, —C≡C—, —CH₂CH₂—, —(CH₂)₄—, —COO—, —OCH₂—, —CH₂O—, —OCF₂—, or —CF₂O—, and the other is a single bond.

13. The liquid crystal element according to claim 1,
wherein the polymerizable compound according to claim 1 comprises at least one or more of disc-like liquid crystal compounds having a structure containing a benzene derivative, a triphenylene derivative, a truxene derivative, a phthalocyanine derivative, or a cyclohexane derivative as a core of the center of a molecule, and a linear alkyl group, a linear alkoxy group, or a substituted benzoyloxy group as substituents being present radially on side chains thereof.

14. The liquid crystal element according to claim 1,
wherein the polymerizable compound according to claim 1 is a polymerizable compound represented by General Formula (6): 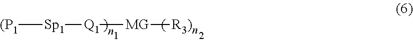
wherein P₁ represents a polymerizable functional group, Sp₁ represents a spacer group having 0 to 20 carbon atoms, Q₁ represents a single bond, —O—, —NH—, —NHCOO—, —OCONH—, —CH═CH—, —CO—, —COO—, —OCO—, —OCOO—, —OOCO—, —CH═CH—, —CH═CH—COO—, —OCO—CH═CH—, or —C≡—, n₁ and n₂ represent 1, 2, or 3, MG represents a mesogen group or a mesogen support group, and R₃ represents a halogen atom, a cyano group, or an alkyl group having 1 to 25 carbon atoms, at least one CH₂ group in the alkyl group may be substituted with —O—, —S—, —NH—, —N(CH₃)—, —CO—, —COO—, —OCO—, —OCOO—, —SCO—, —COS—, or —C≡C— provided that O atoms are not directly adjacent to each other, or R₃ represents P₂—Sp₂-Q₂, and P₂, Sp₂, and Q₂ each are the same as P₁, Sp₁, and Q₁, respectively.

15. The liquid crystal element according to claim 14,
wherein MG of General Formula (6) is a polymerizable compound represented by: 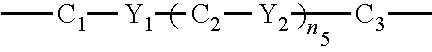
wherein C₁ to C₃ each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2) octylene group, a decahydronaphthalene-2,6-diyl group, a pyridine-2,5-diyl group, a pyrimidine-2,5-diyl group, a pyrazine-2,5-diyl group, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene 2,7-diyl group, or a fluorene 2,7-diyl group, the 1,4-phenylene group, the 1,2,3,4-tetrahydronaphthalene-2,6-diyl group, the 2,6-naphthylene group, the phenanthrene-2,7-diyl group, the 9,10-dihydrophenanthrene-2,7-diyl group, the 1,2,3,4,4a,9,10a-octahydrophenanthrene 2,7-diyl group, and the fluorene 2,7-diyl group may include one or more of F, Cl, CF₃, OCF₃, a cyano group, an alkyl group having 1 to 8 carbon atoms, an alkoxy group, an alkanoyl group, an alkanoyloxy group, an alkenyl group having 2 to 8 carbon atoms, an alkenyloxy group, an alkenoyl group, or an alkenoyloxy group as a substituent, Y₁ and Y₂ each independently represent a —COO—, —OCO—, —CH₂CH₂—, —OCH₂—, —CH₂O—, —CH═CH—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, or a single bond, and n₅ represents 0, 1, or 2.

16. The liquid crystal element according to claim 14,
wherein the polymerizable compound is a polymerizable compound in which Sp₁ and Sp₂ of General Formula (6) each independently represent an alkylene group, the alkylene group is substituted with one or more of halogen atoms or CN, at least one CH₂ group present in this group may be substituted with —O—, —S—, —NH—, —N(CH₃)—, —CO—, —COO—, —OCO—, —OCOO—, —SCO—, —COS—, or —C≡C— provided that O atoms are not directly adjacent to each other.

17. The liquid crystal element according to claim 14,
wherein P₁ and P₂ of the polymerizable compound represented by General Formula (6) each independently represent any one of Formulae (6-a) to (6-d): 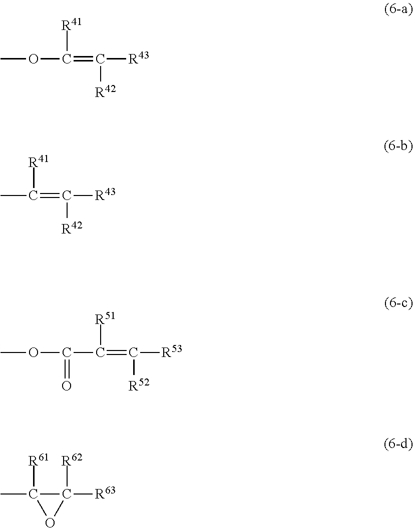
wherein R⁴¹ to R⁴³, R⁵¹ to R⁵³, and R⁶¹ to R⁶³ each independently represent a hydrogen atom, a halogen atom, or an alkyl group having 1 to 5 carbon atoms.

18. The liquid crystal element according to claim 14,
wherein the liquid crystal composition comprises one or more of compounds as the polymerizable compound represented by General Formula (6): 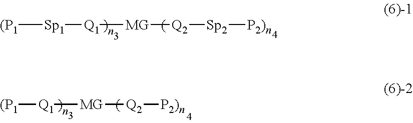
wherein P₁, Sp₁, Q₁, n₃, n₄, MG, P₂, Sp₂, and Q₂ each are the same as defined in claim 14.

19. The liquid crystal element according to claim 14,
wherein the liquid crystal composition comprises one or more of polymerizable compounds represented by General Formulae (6)-3 to (6)-12 as the polymerizable compound represented by General Formula (6): 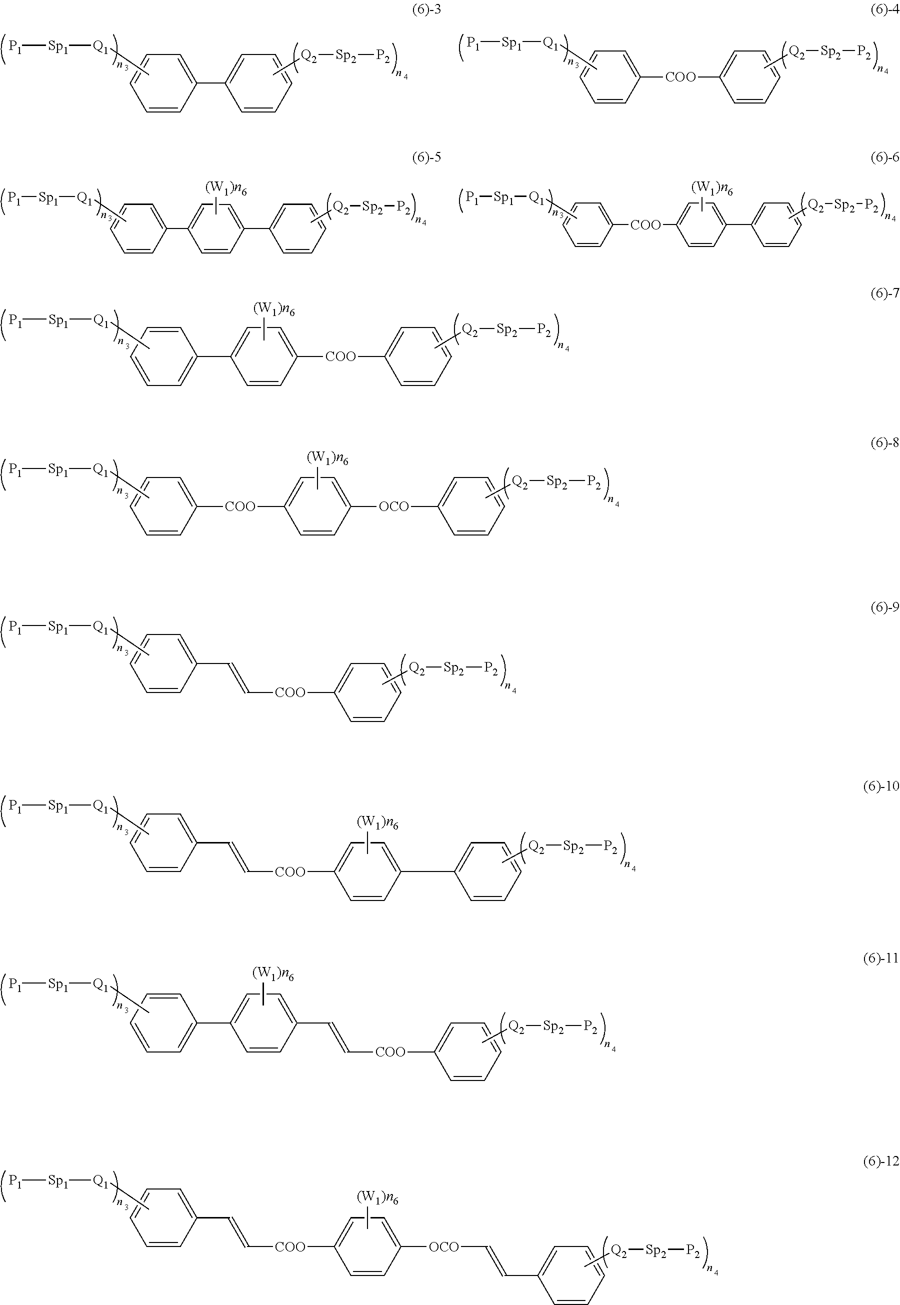
wherein W₁'s each independently represent F, CF₃, OCF₃, CH₃, OCH₃, an alkyl group having 2 to 5 carbon atoms, an alkoxy group, an alkenyl group, COOW₂, OCOW₂, or OCOOW₂, where W₂ represents a linear or branched alkyl group having 1 to 10 carbon atoms or an alkenyl group having 2 to 5 carbon atoms; n₆ represents 0, 1, 2, 3, or 4; and P₁, Sp₁, Q₁, n₃, n₄, P₂, Sp₂, and Q₂ each are the same as defined in claim 14.

20. The liquid crystal element according to claim 14,
wherein the liquid crystal composition comprises one or more of polymerizable compounds represented by General Formula (6) in which at least one of Sp₁, Sp₂, Q₁, and Q₂ is a single bond.

21. The liquid crystal element according to claim 18,
wherein the liquid crystal composition comprises one or more of polymerizable compounds in which n₃+n₄ is from 3 to 6.

22. The liquid crystal element according to claim 14,
wherein the liquid crystal composition comprises one or more of polymerizable compounds in which P₁ and P₂ of General Formula (6) are represented by Formula (6-b): 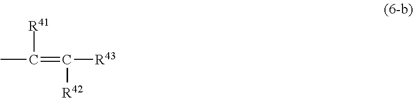
wherein R⁴¹ to R⁴³ each independently represent a hydrogen atom, a halogen atom, or an alkyl group having 1 to 5 carbon atom.

23. The liquid crystal element according to claim 19,
wherein the liquid crystal composition comprises one or more of polymerizable compounds in which W₁ of General Formulae (6)-5 to (6)-8 or (6)-10 to (6)-12 is F, CF₃, OCF₃, CH₃, or OCH₃, and n₆ is equal to or greater than 1.

24. The liquid crystal element according to claim 19,
wherein the liquid crystal composition comprises one or more of a polymerizable compound selected from the compound group represented by General Formulae (6)-5 to (6)-12 as the polymerizable compound.

25. The liquid crystal element according to claim 14,
wherein the liquid crystal composition comprises one or more of disc-like liquid crystal compounds in which MG of Formula (6) is represented by Formula (6)-13: 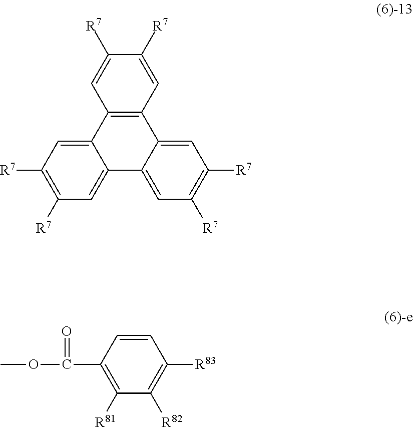
wherein R⁷'s each independently represent P₁-Sp₁-Q₁ or a substituent represented by Formula (6-e), R⁸¹ and R⁸² each independently represent a hydrogen atom, a halogen atom, or a methyl group, R⁸³ represents an alkoxy group having 1 to 20 carbon atoms, and at least one hydrogen atom in the alkoxy group is substituted with a substituent represented by Formulae (6-a) to (6-d): 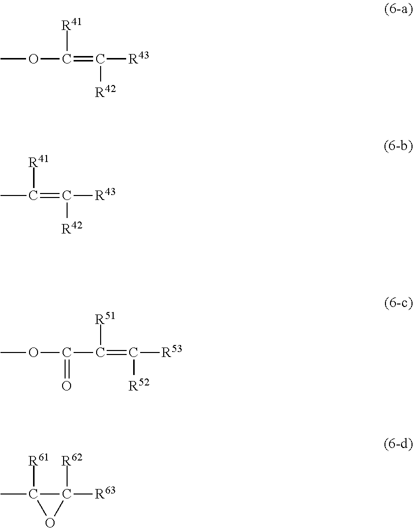
wherein R⁴¹ to R⁴³, R⁵¹ to R⁵³, and R⁶¹ to R⁶³ each independently represent a hydrogen atom, a halogen atom, or an alkyl group having 1 to 5 carbon atom.

26. The liquid crystal element according to claim 1,
wherein the liquid crystal composition substantially does not comprise an initiator.

27. The liquid crystal element according to claim 1,
wherein the liquid crystal composition comprises the polymerizable compound in an amount of 0.1% to 2.0% by weight.

28. A liquid crystal display device comprising the liquid crystal element according to claim 1.

29. The liquid crystal display device according to claim 28,
wherein an active element is provided on the transparent electrode.

30. The liquid crystal display device according to claim 28,
wherein driving display of a VA mode is performed.

31. A liquid crystal composition used in the liquid crystal element according to claim 1.
